(19) United States
(12) Patent Application Publication
(10) Pub. No.: US 2026/0368132 A1
(43) Pub. Date: Nov. 19, 2026

(54) Efficient KV cache transfer between different pools of reconfigurable processor circuitry

(71) Applicant: SambaNova Systems, Inc., Palo Alto, CA (US)

(72) Inventors: Joshua BROT, Palo Alto, CA (US); Roshan THEKINIATH, Naperville, IL (US); Jiayu BAI, Palo Alto, CA (US); Chih-Hao WANG, Santa Clara, CA (US); Reid GOODBAR, Palo Alto, CA (US)

(73) Assignee: SambaNova Systems, Inc., Palo Alto, CA (US)

(21) Appl. No.: 19/331,440

(22) Filed: Sep. 17, 2025

Related U.S. Application Data
(60) Provisional application No. 63/808,196, filed on May 19, 2025.

(51) Int. Cl. G06F 15/78

(52) U.S. Cl. CPC G06F 15/7882; G06F 15/7839

(57) ABSTRACT

A data processing system includes first and second pools of reconfigurable processor circuitry, first and second memory circuitry, a DMA engine for transferring data from the first to the second memory circuitry, one or more host processors coupled to a storage medium, and a compiler that is executable in any of the one or more host processors. The compiler is configured to generate first and second configuration files. The first configuration file includes instructions for configuring the first pool of reconfigurable processor circuitry to implement a prefill phase of an LLM inference on the first pool of reconfigurable processor circuitry. The second configuration file includes instructions for configuring the second pool of reconfigurable processor circuitry based on the first configuration file to implement a decode phase of the LLM inference on the second pool of reconfigurable processor circuitry.

This application claims the benefit of U.S. Provisional Patent Application No. 63/808,196, entitled, “Efficient KV Cache Transfer Between Different Pools of Reconfigurable Processor Circuitry” filed on 19 May 2025. The provisional application is hereby incorporated by reference for all purposes.

### REFERENCES

The following are incorporated by reference for all purposes:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018; and

Each publication, patent, and/or patent application mentioned in this specification is herein incorporated by reference in its entirety to the same extent as if each individual publication and/or patent application was specifically and individually indicated to be incorporated by reference.

### BACKGROUND

### Technical Field

The disclosed implementations relate generally to the execution of a Large Language Model (LLM) in pools of reconfigurable processor circuitry. In particular, it relates to the efficient transfer of a key-value (KV) cache from a first pool of reconfigurable processor circuitry that implements the prefill phase of LLM inference to a second pool of reconfigurable processor circuitry that implements the decode phase of LLM inference.

### CONTEXT

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

A Large Language Model (LLM) consists of a sequence of operations, where each operation takes as input two tensors of numbers, one of which comes originally from a user and is called the “activation” and one of which is hardcoded, called the “weight.” The output of each operation becomes the activation for the next operation. The initial input to the LLM corresponds to user provided text, which is sometimes also referred to as the prompt, while the last output from the LLM is a prediction for the next few characters in the provided text.

### BRIEF DESCRIPTION OF THE DRAWINGS

The technology will be described with reference to the drawings, in which:

FIG. 1 illustrates an example system including a coarse-grained reconfigurable (CGR) processor, a host, and a memory.

FIG. 2 illustrates an example of a computer, including an input device, a processor, a storage device, and an output device.

FIG. 3 illustrates example details of a CGR architecture including a top-level network (TLN) and two CGR arrays.

FIG. 4 illustrates an example CGR array, including an array of CGR units in an array-level network (ALN).

FIG. 5 illustrates an example of a pattern memory unit (PMU) and a pattern compute unit (PCU), which may be combined in a fused-control memory unit (FCMU).

FIG. 6A illustrates a data processing system in which applications are implemented on reconfigurable processors.

FIG. 6B illustrates an example data processing system with a compiler that generates different configuration files for configuring reconfigurable processor circuitry and associated memory circuitry according to a prefill phase and according to a decode phase of an LLM inference with memory sharing between the different configurations of the LLM.

FIG. 7 illustrates an implementation of a configuration file used by the technology disclosed to configure reconfigurable processors according to a configuration that is based on a processing graph of an application.

FIG. 8A illustrates an example implementation of an LLM inference with a prefill phase implemented in a first pool of reconfigurable processor circuitry, a decode phase implemented in a second pool of reconfigurable processor circuitry, and first and second memory circuitry that is coupled via a network for an efficient KV cache transfer between the first and second pools of reconfigurable processor circuitry.

FIG. 8B illustrates an example implementation of an LLM inference with a prefill phase implemented in several pools of reconfigurable processor circuitry with associated reconfigurable processor memory, a decode phase implemented in several other pools of reconfigurable processor circuitry with other associated reconfigurable processor memory, and a network that couples the reconfigurable processor memories.

FIG. 9 illustrates an example data processing system including two pools of reconfigurable processor circuitry that are coupled by a network and configured for transferring data via a direct memory access (DMA) from first reconfigurable processor memory associated with the first pool of reconfigurable processor circuitry to second reconfigurable processor memory associated with the second pool of reconfigurable processor circuitry.

FIG. 10 is a flowchart with illustrative operations that a compiler that is executable in one or more processors coupled to a storage medium performs for implementing a prefill phase of an LLM inference on a first pool of reconfigurable processor circuitry and for implementing a decode phase of the LLM inference on a second, different pool of reconfigurable processor circuitry.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope as claimed. Instead, they merely represent examples of different implementations.

### DETAILED DESCRIPTION

Deep learning is a subset of machine learning algorithms that are inspired by the structure and function of the human brain. Most deep learning algorithms involve artificial neural network architectures, in which multiple layers of neurons each receive input from neurons in a prior layer or layers, and in turn influence the neurons in the subsequent layer or layers. Training these neural network models can be computationally extremely demanding.

As machine learning based technologies are more widely deployed, it is becoming important to implement them at low cost using flexible hardware architectures. In such architectures, including integrated circuit components, area, and power consumption are critical design parameters. One class of integrated circuits includes reconfigurable processor integrated circuits, which are sometimes also simply referred to as reconfigurable processors.

Reconfigurable processors can be configured to implement a variety of functions. In particular, so-called Coarse-Grained Reconfigurable Architectures (CGRAs) are being developed in which the configurable units in the array are complex and that may enable faster or more efficient execution of various classes of functions. For example, CGRAs have been proposed that can enable implementation of energy-efficient accelerators for machine learning and artificial intelligence workloads. See, Prabhakar, et al., “Plasticine: A Reconfigurable Architecture for Parallel Patterns,” ISCA '17, Jun. 24-28, 2017, Toronto, ON, Canada. Various aspects of some of such CGRAs are described in the above-incorporated patent applications.

A CGRA typically includes an array of reconfigurable units and operate on streams of data and control messages that flow through a sea of these reconfigurable units, sometimes referred to herein as Coarse-Grained Reconfigurable Units (CGRUs). The units can comprise somewhat specialized computational and memory units.

As mentioned above, a Large Language Model (LLM) inference includes a sequence of operations, where each operation takes as input two tensors of numbers, one of which is called the “activation” and one of which is hardcoded, called the “weight.” The output of each operation becomes the activation for the next operation. The initial input to the LLM corresponds to user provided text, the so-called “prompt”, while the last output from the LLM is generated text based on the prompt.

LLM inference can involve two phases, a prefill phase and a decode phase. During the prefill phase, the LLM converts the prompt into tokens and produces intermediate states, in particular keys and values in form of the key-value (KV) cache which stores information about the tokens and which is used to generate a first new token. Therefore, the time spent in the prefill phase is sometimes also referred to as “time-to-first-token (TTFT)”.

The prefill phase is computationally intensive due to the high operational intensity in its compute graph in which each new token including the first token is generated based on all previous tokens, which in the case of the first token are all known. Therefore, the prefill phase is sometimes also referred to as being “compute-bound”. In other words, when being executed on reconfigurable processor circuitry, the primary bottleneck of determining the first token in the prefill phase is the computational capacity of the reconfigurable processor circuitry.

During the decode phase, the LLM generates an answer to the prompt and provides the answer to the user by iteratively adding one output token at a time to the KV cache. Thereby, each output token is generated based on all previous tokens in the KV cache, requiring many memory access operations during each iteration. Therefore, the decode phase is sometimes also referred to as being “memory-bound”. In other words, when being executed on reconfigurable processor circuitry, the primary bottleneck of generating a new token in the decode phase is the speed of the memory access operations. The time spent to produce one token in the decode phase is sometimes also referred to as “time-per-output-token (TPOT)”.

Disaggregating the prefill phase and the decode phase by implementing the prefill phase and the decode phase using different pools of reconfigurable processor circuitry can improve the overall performance of LLM inference. In particular, the prefill phase can be implemented by a first pool of reconfigurable processor circuitry which can be configured to employ various different techniques that improve time-to-first-token (TTFT). Illustratively, such techniques include the prepacking of input sequences, speculative decoding, chunked prefill, quantization, and/or token pruning. The decode phase can be implemented by a second pool of reconfigurable processor circuitry which can be configured to employ various different techniques that improve time-per-output-token (TPOT). Illustratively, such techniques include efficient batching such as continuous batching or dynamic batching and/or attention mechanism optimization such as fusing attention computations into a single kernel.

Batching is the practice of bundling several sequences of operations together to respond to dynamic hardware load changes and achieve better hardware utilization. Thereby, batching can significantly improve the time-per-output-token and thereby the compute utilization and the cost of the decode phase. During continuous batching, execution of a new sequence of operations can be started in the pool of reconfigurable processor circuitry as soon as another sequence of operations has emitted an end-of-sequence token. For example, whenever a sequence of operations finishes in the decode phase, a new sample is swapped in from the prefill phase via the KV cache.

To execute an LLM on reconfigurable processors, a compiler needs to generate a configuration file, sometimes also referred to as “program execution file (PEF)”. The configuration file is used to configure the reconfigurable processors and the associated reconfigurable processor memory to execute the LLM.

For disaggregating the implementation of the prefill phase of the LLM inference from the decode phase of the LLM inference by implementing the two phases on separate pools of reconfigurable processor circuitry, it is desirable to ensure efficient KV-cache communication and memory management between the separate pools of reconfigurable processor circuitry. In particular, it is desirable that a compiler generates two different configuration files for two different pools of reconfigurable processor circuitry such that the KV cache can validly be transferred as a single block from a first pool of reconfigurable processor circuitry that implements the prefill phase to a second pool of reconfigurable processor circuitry that implements the decode phase.

For this purpose, the compiler generates a first configuration file for the first pool of reconfigurable processor circuitry and a second configuration file for the second pool of reconfigurable processor circuitry such that the first configuration file configures the first pool of reconfigurable processor circuitry according to a first configuration that implements the prefill phase of the LLM inference and the second configuration file configures the second pool of reconfigurable processor circuitry according to a second configuration that implements the decode phase of the LLM inference, whereby both configuration files also configure associated storage circuitry as shared memory such that the KV cache can be shared between the first pool of reconfigurable processor circuitry that implements the prefill phase and the second pool of reconfigurable processor circuitry that implements the decode phase.

The technology disclosed herein provides such systems and methods. In particular, the disclosed technology provides one or more host processors coupled to a storage medium and a compiler that is executable in any of the one or more host processors. Thereby, the compiler generates a first configuration file for configuring a first pool of reconfigurable processor circuitry for implementing and executing a prefill phase of an LLM inference and a second configuration file for configuring a second pool of reconfigurable processor circuitry for implementing and executing a decode phase of an LLM inference. The first configuration file and the second configuration file configure first and second memory circuitry, respectively, to implement the KV cache, whereby the physical representation of the KV cache in the first and second memory circuitry is isomorphic. Thus, the first pool of reconfigurable processor circuitry writes the keys and values to first memory circuitry, and the second pool of reconfigurable processor circuitry reads the keys and values from the second memory circuitry. A direct memory access (DMA) engine validly transfers the keys and values and thus the contents of the KV cache via a network (e.g., by Ethernet) from the first to the second memory circuitry, and thus from the first to the second pool of reconfigurable processor circuitry.

### TERMINOLOGY

As used herein, the phrase “one of” should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms “comprising” and “consisting” have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B”. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms “substantially”, “close”, “approximately”, “near”, and “about” refer to being within minus or plus 10% of an indicated value, unless explicitly specified otherwise.

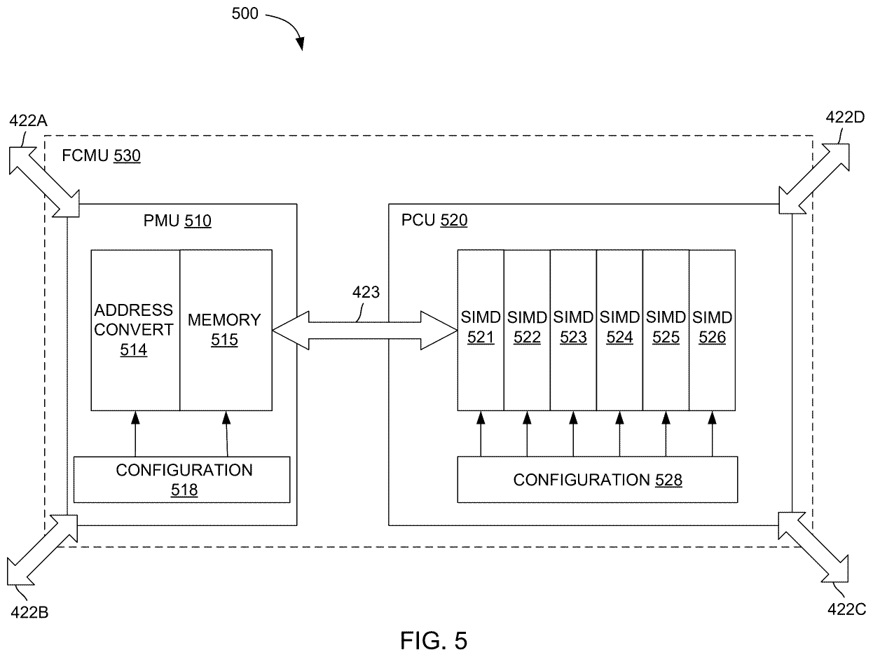

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units.
CGR Array—an array of CGR units, coupled with each other through an array-level network (ALN), and coupled with external elements via a top-level network (TLN). A CGR array can physically implement the nodes and edges of a dataflow graph.
CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in processing graphs and dataflow graphs. Further examples of CGR units include a CU and an AG, which may be combined in an AGCU. Some implementations include CGR switches, whereas other implementations may include regular switches.
CPA—column power accumulator.
Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 5.
Processing graph—some algorithms can be represented as processing graphs. As used herein, processing graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the processing graph reveals which operations and/or expressions can be executed concurrently.
CU—coalescing unit.
Data Flow Graph—a processing graph that includes one or more loops that may be nested, and wherein nodes can send messages to nodes in earlier layers to control the dataflow between the layers.
Datapath—a collection of functional units that perform data processing operations. The functional units may include memory, multiplexers, ALUs, SIMDs, multipliers, registers, buses, etc.
FCMU—fused compute and memory unit—a circuit that includes both a memory unit and a compute unit.
FSM—finite state machine.
GCC—global control circuit.
GPA—global power accumulator.
Graph—a collection of nodes connected by edges. Nodes may represent various kinds of items or operations, dependent on the type of graph. Edges may represent relationships, directions, dependencies, etc.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
KV cache—key-value cache.
LCC—local control circuit.
LLM—large language model.
LPA—local power accumulator.
LUT—lookup table.
ML—machine learning.
PBU—power base unit—a combination of a switch, a memory unit, and a compute unit including one or more power estimators.
PCMC—power clock management controller.
PCU—pattern compute unit—a compute unit that can be configured to repetitively perform a sequence of operations.
PE—Power estimator.
PEF—Program execution file—a configuration file for configuring reconfigurable circuitry and associated memory circuitry.
PICN—Power information and control network.
Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a meta-pipeline at the graph execution level (typically a sequence of logical operations that are to be repetitively executed) that enables correct timing and loop control of node-level operations of the configured graph. Gate-level pipelines are usually hard wired and unchangeable, whereas meta-pipelines are configured at the CGR processor, CGR array level, and/or GCR unit level.
Pipeline Stages—a pipeline is divided into stages that are coupled with one another to form a pipe topology.
PMU—pattern memory unit—a memory unit that can locally store data according to a programmed pattern.
SIMD—single-instruction multiple-data—an arithmetic logic unit (ALU) that simultaneously performs a single programmable operation on multiple data elements delivering multiple output results.
TLN—top-level network.

### IMPLEMENTATIONS

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

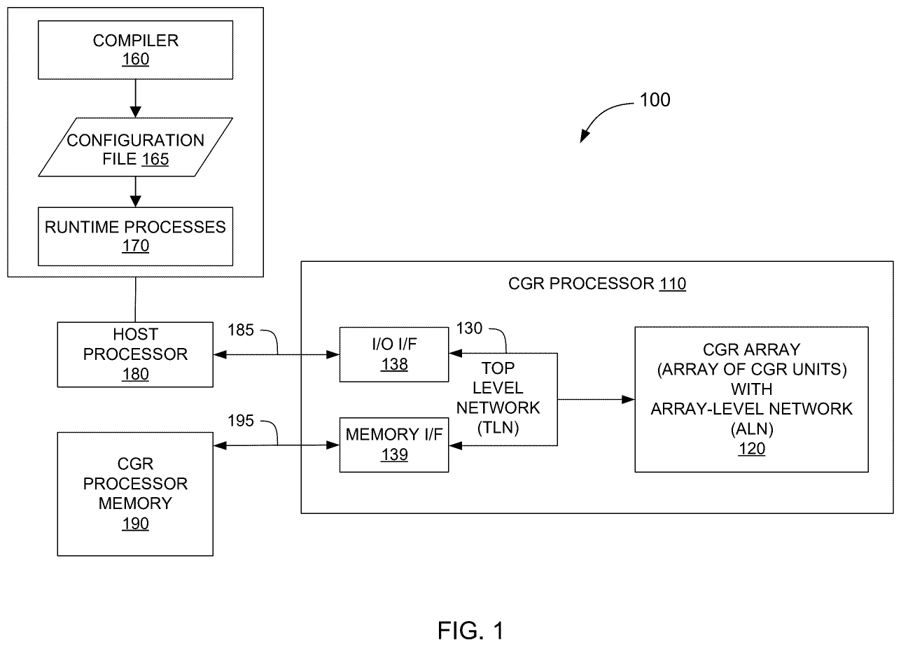

FIG. 1 illustrates an example system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via databus 130 which may be part of a top-level network (TLN). Host 180 communicates with IO interface 138 via system databus 185, and memory interface 139 communicates with memory 190 via memory bus 195. Array of CGR units 120 may further include compute units and memory units that are connected with an array-level network (ALN) to provide the circuitry for execution of a processing graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, processing graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 110. In some implementations, CGR processor 110 may include one or more ICs. In other implementations, a single IC may span multiple CGR processors. In further implementations, CGR processor 110 may include one or more units of array of CGR units 120.

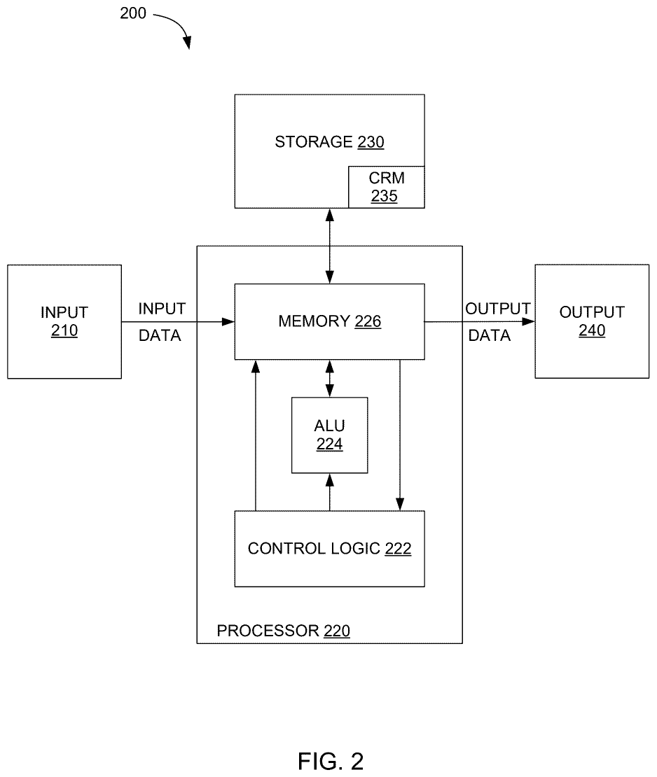

Host 180 may be, or include, a computer such as further described with reference to FIG. 2. Host 180 runs runtime processes, as further referenced herein, and may also be used to run computer programs, such as the compiler 160. In some implementations, the compiler 160 may run on a computer that is similar to the computer described with reference to FIG. 2, but separate from host 180.

CGR processor 110 may accomplish computational tasks by executing a configuration file 165. For the purposes of this description, a configuration file corresponds to a dataflow graph, or a translation of a dataflow graph, and may further include initialization data. A compiler 160 compiles the high-level program to provide the configuration file 165. Runtime processes 170 may install the configuration file 165 in CGR processor 110. In some implementations described herein, a CGR array 120 is configured by programming one or more configuration stores with all or parts of the configuration file 165. A single configuration store may be at the level of the CGR processor 110 or the CGR array 120, or a CGR unit may include an individual configuration store. The configuration file 165 may include configuration data for the CGR array 120 and CGR units in the CGR array 120, and link the processing graph to the CGR array 120. Execution of the configuration file by CGR processor 110 causes the CGR array 120 to implement the user algorithms and functions in the dataflow graph.

CGR processor 110 can be implemented on a single integrated circuit (IC) die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor 110. Input device 210 is coupled with processor 220 to provide input data, which an implementation may store in memory 226. Processor 220 is coupled with output device 240 to provide output data from memory 226 to output device 240. Processor 220 further includes control logic 222, operable to control memory 226 and arithmetic and logic unit (ALU) 224, and to receive program and configuration data from memory 226. Control logic 222 further controls exchange of data between memory 226 and storage device 230. Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 includes a non-transitory computer-readable medium (CRM 235), such as used for storing computer programs.

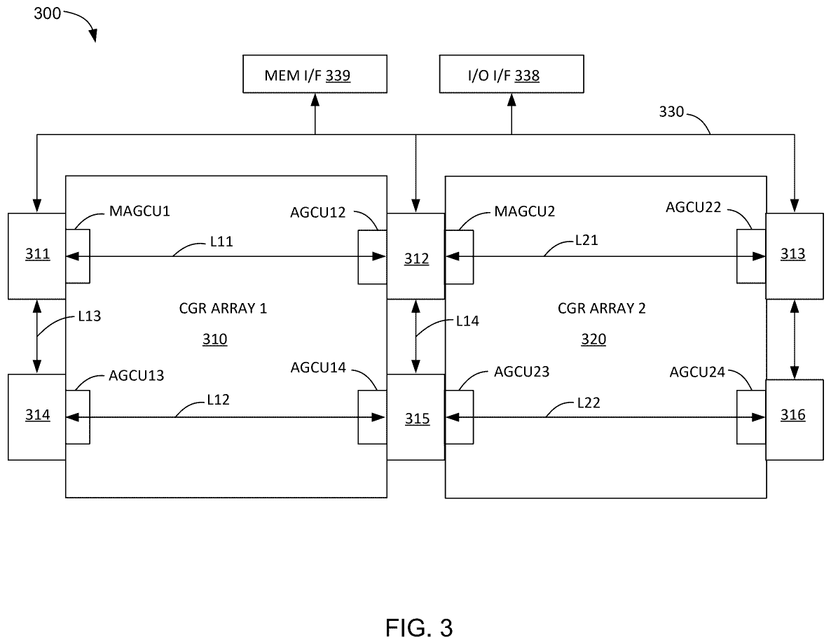

FIG. 3 illustrates example details of a CGR architecture 300 including a top-level network (TLN 330) and two CGR arrays (CGR array 310 and CGR array 320). A CGR array comprises an array of CGR units (e.g., PMUs, PCUs, FCMUs) coupled via an array-level network (ALN), e.g., a bus system. The ALN is coupled with the TLN 330 through several AGCUs, and consequently with I/O interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., a master AGCU (MAGCU) labeled MAGCU1, and three other AGCUs labeled AGCU12, AGCU13, and AGCU14 in CGR array 310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 311, switch 312, switch 313, switch 314, switch 315, and switch 316) coupled with each other as well as with other circuits on the TLN, including the AGCUs, external I/O interface 338, and external memory interface 339. The TLN includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

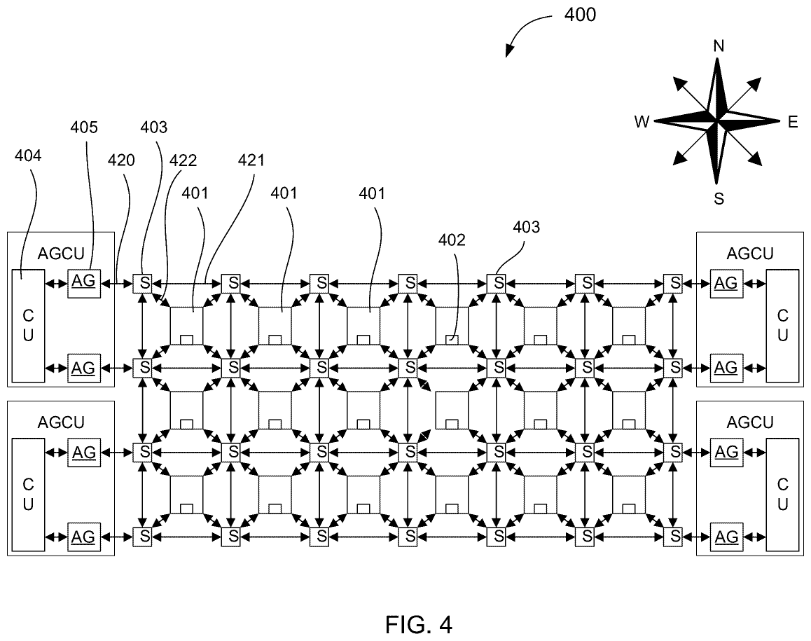

FIG. 4 illustrates an example CGR array 400, including an array of CGR units in an ALN. CGR array 400 may include several types of CGR unit 401, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017, Jun. 24-28, 2017, Toronto, ON, Canada. Each of the CGR units may include a configuration store 402 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns. The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

As shown in FIG. 4, a CGR unit 401 may have four ports to interface with switch units 403, or any other number of ports suitable for an ALN. Each port may be suitable for receiving and transmitting data, or a port may be suitable for only receiving or only transmitting data.

A switch unit 403, as shown in the example of FIG. 4, may have eight interfaces. The North, South, East and West interfaces of a switch unit 403 may be used for links between switch units using interconnects 421. The Northeast, Southeast, Northwest and Southwest interfaces of a switch unit 403 may each be used to make a link with an FCMU, PCU or PMU instance using one of the interconnects 422. Two switch units 403 in each CGR array quadrant have links to an AGCU using interconnects 420. The AGCU coalescing unit 404 arbitrates between the AGs 405 and processes memory requests. Each of the eight interfaces of a switch unit 403 can include a vector interface, a scalar interface, and a control interface to communicate with the vector network, the scalar network, and the control network. In other implementations, a switch unit 403 may have any number of interfaces.

During execution of a graph or subgraph in a CGR array after configuration, data can be sent via one or more switch units 403 and one or more links between the switch units 403 to the CGR units 401 using the vector bus and vector interface(s) of the one or more switch units on the ALN. A CGR array may comprise at least a part of CGR array 400, and any number of other CGR arrays coupled with CGR array 400.

A data processing operation implemented by CGR array configuration may comprise multiple graphs or subgraphs specifying data processing operations that are distributed among and executed by corresponding CGR units (e.g., FCMUs, PMUs, PCUs) as well as AGs, and CUs.

FIG. 5 illustrates an example 500 of a PMU 510 and a PCU 520, which may be combined in an FCMU 530. PMU 510 may be directly coupled to PCU 520, or optionally via one or more switches. PMU 510 includes a scratchpad memory 515, which may receive external data, memory addresses, and memory control information (e.g., write enable, read enable, etc.) via one or more buses included in the ALN. PCU 520 includes two or more processor stages, such as SIMD 521 through SIMD 526, and configuration store 528. The processor stages may include ALUs, or SIMDs, as drawn, or any other reconfigurable data processing stages.

Each stage in PCU 520 may also hold one or more registers (not shown) for short-term storage of parameters. Short-term storage, for example during one to several clock cycles or unit delays, allows for synchronization of data in the PCU pipeline.

### Generating Configuration Files for Implementing Prefill and Decode Phase of LLM Inference in Separate Pools of Reconfigurable Processor Circuitry

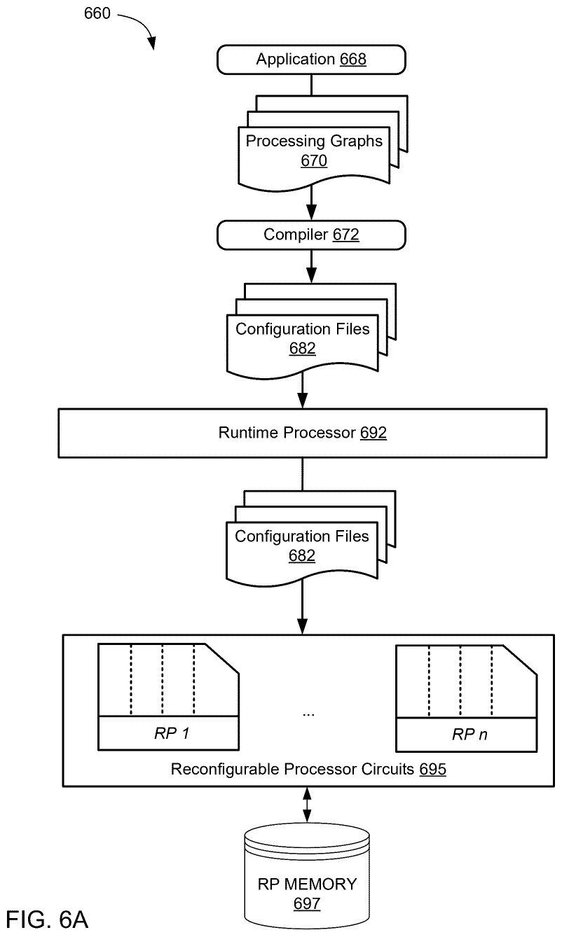

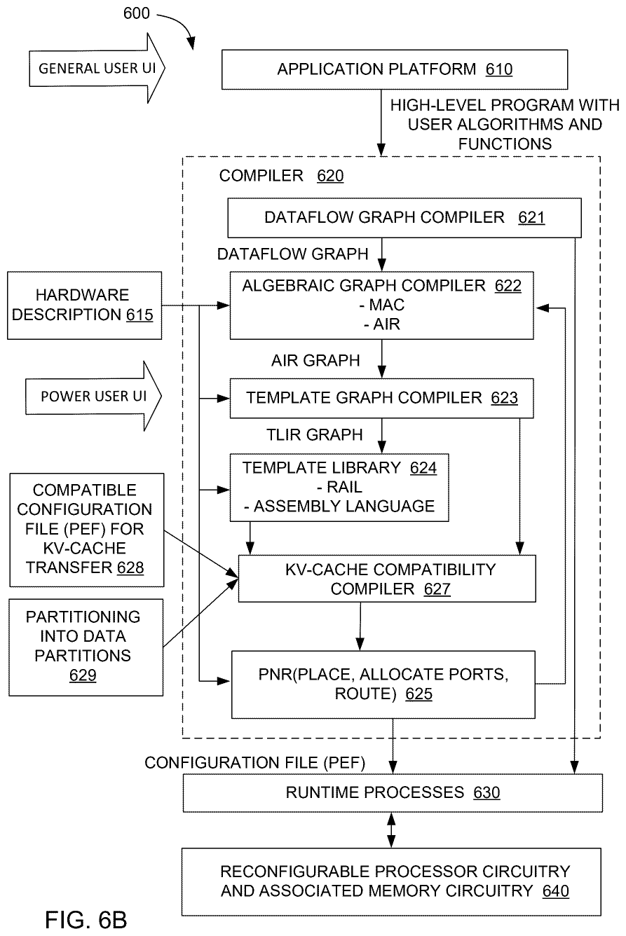

FIG. 6A shows a data processing system 660 that provides on-demand network access to reconfigurable processors circuits 695 RP 1 to RP n, which are sometimes also simply referred to as reconfigurable processors 695. The reconfigurable processor circuits 695 can be rapidly provisioned and released with minimal management effort or service provider interaction. A reconfigurable processor of the reconfigurable processors 695 includes reconfigurable processor circuitry (e.g., compute units 520 and memory units 510 of FIG. 5). The reconfigurable processor circuitry can be arranged in arrays of coarse-grained reconfigurable (CGR) units. The arrays of CGR units may be embedded in a programmable interconnect fabric. The arrays of CGR units in a reconfigurable processor are partitionable into a plurality of subsets (or tiles) of arrays of CGR units.

Bus (or transfer) resources interconnect the reconfigurable processors 695 and enable the reconfigurable processors 695 to receive and send data. Examples of the bus resources include PCIe channels, DMA channels, and DDR channels. The reconfigurable processors 695 are coupled to memory (or storage) circuitry such as reconfigurable processor (RP) memory 697 usable to store data. The reconfigurable processor circuitry in the reconfigurable processors 695 is configured to access the memory circuitry via a DDR interface or a high-bandwidth memory (HBM) interface, if desired. Examples of the memory circuitry include main memory (e.g., off-chip/external DRAM), local secondary storage (e.g., local disks (e.g., HDD, SSD)), and remote secondary storage (e.g., distributed file systems, web servers). Other examples of the memory circuitry include latches, registers, and caches (e.g., SRAM).

The reconfigurable processors 695 are dynamically scalable to meet the performance objectives required by applications 668 (or user applications 668). The applications 668 access the reconfigurable processors 695 over one or more networks (e.g., Internet). Thus, a pool of reconfigurable processor circuitry can have different compute scales and hierarchies according to different implementations of the technology disclosed.

In one example, a pool of reconfigurable processor circuitry can include a portion of a single reconfigurable processor circuit (e.g., reconfigurable processor circuitry in RP 1 of reconfigurable processor circuits 695). In another example, a pool of reconfigurable processor circuitry includes a node (or a single machine) that has one or more reconfigurable processors, supported by required bus and memory circuitry. The node also includes a host processor (e.g., CPU) that exchanges data with the reconfigurable processors, for example, over a PCIe interface. The host processor includes a runtime processor 692 that manages resource allocation, memory mapping, and execution of the configuration files 682 for applications 668 requesting execution from the host processor. In yet another example, the pool of reconfigurable processor circuitry includes a rack (or cluster) of nodes such that each node in the rack runs a respective plurality of reconfigurable processors, and includes a respective host processor configured with a respective runtime processor. The runtime processors are distributed across the nodes and communicate with each other so that they have unified access to the reconfigurable processors attached not just to their own node on which they run, but also to the reconfigurable processors attached to every other node in the data center.

The nodes in the rack are connected, for example, over Ethernet or InfiniBand (IB). In yet another example, the pool of reconfigurable processor circuitry includes a pod that comprises a plurality of racks. In yet another example, the pool of reconfigurable processor circuitry is a superpod that comprises a plurality of pods. In yet another example, the pool of reconfigurable processor circuitry is a zone that comprises a plurality of superpods. In yet another example, the pool of reconfigurable processor circuitry is a data center that comprises a plurality of zones.

The applications 668 are executed on the pool of reconfigurable processor circuitry in a distributed fashion by programming the reconfigurable processor circuitry which includes individual compute and memory components to asynchronously receive, process, and send data and control information. In the reconfigurable processors 695, computation can be executed as deep, nested dataflow pipelines that exploit nested parallelism and data locality very efficiently. These dataflow pipelines contain several stages of computation, where each stage reads data from one or more input buffers with an irregular memory access pattern, performs computations on the data while using one or more internal buffers to store and retrieve intermediate results, and produce outputs that are written to one or more output buffers. The structure of these pipelines depends on the control and dataflow graph representing the application. Pipelines can be arbitrarily nested and looped within each other.

The applications 668 comprise high-level programs. A high-level program may include source code written in programming languages like C, C++, Java, JavaScript, Python, and/or Spatial, for example, using deep learning frameworks such as PyTorch, TensorFlow, ONNX, Caffe, and/or Keras. The high-level program can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and/or Transformer-XL.

In one example, the high-level program can implement a prefill phase of a large language model (LLM) inference. In another example, the high-level program can implement a decode phase of an LLM inference. In these examples, the high-level program that implements the prefill phase can include instructions for storing the KV-cache in first memory circuitry, and the high-level program that implements the decode phase can include instructions for retrieving the KV-cache from second memory circuitry. In this example, a direct memory access (DMA) engine can transfer the KV-cache contents from the first to the second memory circuitry.

The high-level program can include several processing layers that execute operations. The high-level program can execute irregular memory operations that involve accessing inputs and weights and storing generated outputs. As an example, the high-level program can perform matrix multiplications between the inputs and the weights to generate the outputs. The high-level program can include nested loops with high iteration count and loop bodies that load and multiply input values from a preceding processing layer with weights from memory circuitry to produce an output for the succeeding processing layer. The high-level program can have loop-level parallelism of the outermost loop body, which can be exploited using coarse-grained pipelining. The high-level program can have instruction-level parallelism of the innermost loop body, which can be exploited using loop unrolling, SIMD vectorization, and pipelining.

The applications 668 are provided to a compiler in form of processing graphs (e.g., data flow graphs, control graphs) 670. The processing graphs 670 comprise nodes and edges. The nodes can represent compute operations and memory allocations. The edges can represent data flow and flow control. In some implementations, each loop in the high-level programs can be represented as a “controller” in the processing graphs 670. The processing graphs 670 support branches, loops, function calls, and other variations of control dependencies. In some implementations, after the processing graphs 670 are generated, additional analyses or optimizations focused on loop transformations can be performed, such as loop unrolling, loop pipelining, loop fission/fusion, and loop tiling.

A compiler 672 transforms the processing graphs 670 into a hardware-specific configuration, which is specified in configuration files 682 generated by the compiler 672.

In one scenario, the processing graph 670 includes a prefill phase of a large language model (LLM) inference, the compile 672 generates a configuration file 682 for the processing graph 670 such that the configuration file 682 is adapted for configuring a first pool of reconfigurable processor circuitry in the reconfigurable processor circuits 695 to implement the prefill phase of an LLM inference. Illustratively, the configuration file 682 may include instructions that when configured in the first pool of reconfigurable processor circuitry cause the first pool of reconfigurable processor circuitry to implement techniques that improve a time-to-first-token (TTFT) including the prepacking of input sequences, speculative decoding, chunked prefill, quantization, and/or token pruning.

In another scenario, the processing graph 670 includes a decode phase of a large language model (LLM) inference, the compile 672 generates a configuration file 682 for the processing graph 670 such that the configuration file 682 is adapted for configuring a second pool of reconfigurable processor circuitry in the reconfigurable processor circuits 695 to implement the decode phase of an LLM inference. Illustratively, the configuration file 682 may include instructions that when configured in the second pool of reconfigurable processor circuitry cause the second pool of reconfigurable processor circuitry to implement techniques that improve time-per-output-token (TPOT) including efficient batching such as continuous batching or dynamic batching and/or attention mechanism optimization such as fusing attention computations into a single kernel. For example, the second pool of reconfigurable processor circuitry may be configured to start a new sequence of operations with a new sample as soon as another sequence of operations has ended (e.g., by emitting an end-of-sequence token). Illustratively, the new sample is swapped in from the prefill phase via the KV cache.

Illustratively, the compiler 672 generates instructions in the configuration file 682 for implementing the prefill phase that cause the first pool of reconfigurable processor circuitry to store the generated keys and values of the KV cache in first memory circuitry according to a predefined placement, partitioning, and layout. If desired, the compiler 672 generates associated instructions in the configuration file 682 for implementing the decode phase that cause the second pool of reconfigurable processor circuitry to retrieve the keys and values of the KV cache from second memory circuitry according to the same predefined placement, partitioning, and layout, thereby providing for an efficient transfer of the keys and values of the KV cache from the prefill phase to the decode phase. For example, the configuration files 682 can include instructions such that the keys and values of the KV-cache are divided in data partitions and each data partition of the data partitions is stored and retrieved as a single block.

In one implementation, the compiler 672 partitions the processing graphs 670 into memory allocations and execution fragments, and these partitions are specified in the configuration files 682. Execution fragments represent operations on data. An execution fragment can comprise portions of a program representing an amount of work. An execution fragment can comprise computations encompassed by a set of loops, a set of graph nodes, or some other unit of work that requires synchronization. An execution fragment can comprise a fixed or variable amount of work, as needed by the program. Different ones of the execution fragments can contain different amounts of computation. Execution fragments can represent parallel patterns or portions of parallel patterns and are executable asynchronously.

Memory allocations represent the creation of logical memory spaces in on-chip and/or off-chip memory circuitry for data required to implement the processing graphs 670, and these memory allocations are specified in the configuration files 682. Memory allocations define the type and the number of hardware resources (functional units, storage, or connectivity components). Main memory (e.g., DRAM) is off-chip memory for which the memory allocations can be made. Scratchpad memory (e.g., SRAM) is on-chip memory for which the memory allocations can be made. Other memory types for which the memory allocations can be made for various access patterns and layouts include read-only lookup-tables (LUTs), fixed size queues (e.g., FIFOs), and register files.

The compiler 672 binds memory allocations to virtual memory units and binds execution fragments to virtual compute units, and these bindings are specified in the configuration files 682. In some implementations, the compiler 672 partitions execution fragments into memory fragments and compute fragments, and these partitions are specified in the configuration files 682.

A memory fragment comprises address calculations leading up to a memory access. A compute fragment comprises all other operations in the parent execution fragment. A single execution fragment can produce one or more memory fragments, depending on how many memory accesses exist in the original loop body. In cases where the same memory addressing logic is shared across multiple memory accesses, address calculation may be duplicated to create multiple memory fragments from the same execution fragment.

The memory fragments of the execution fragments are configured to index into data structures. At least one of the memory fragments indexes into a data structure in the logical memory spaces of one of the memory allocations.

The compiler 672 assigns the memory fragments to the virtual memory units and assigns the compute fragments to the virtual compute units, and these assignments are specified in the configuration files 682. Each memory fragment is mapped operation-wise to the virtual memory unit corresponding to the memory being accessed. Each operation is lowered to its corresponding configuration intermediate representation for that virtual memory unit. Each compute fragment is mapped operation-wise to a newly allocated virtual compute unit. Each operation is lowered to its corresponding configuration intermediate representation for that virtual compute unit.

The compiler 672 allocates the virtual memory units to physical memory units of reconfigurable processors 695 (e.g., pattern memory units (PMUs) of one of the reconfigurable processors 695) and allocates the virtual compute units to physical compute units of reconfigurable processors 695 (e.g., pattern compute units (PCUs) of one of the reconfigurable processors 695), and these allocations are specified in the configuration files 682. The compiler 672 places the physical memory units and the physical compute units onto positions in an array of CGR units of the reconfigurable processors 695 and routes data and control networks between the placed positions, and these placements and routes are specified in the configuration files 682. In one implementation, this includes allocating physical resources such as counters and registers within each physical memory and compute unit, and these allocations are specified in the configuration files 682.

The compiler 672 may translate the applications 668 developed with commonly used open-source packages such as Keras and/or PyTorch into reconfigurable processor specifications. The compiler 672 generates the configuration files 682 with configuration data for the placed positions and the routed data and control networks.

Illustratively, the compiler 672 generates in the configuration files 682 instructions for storing data in memory circuitry such as RP memory 697 and instructions for retrieving data from the memory circuitry such as from RP memory 697. For example, the compiler 672 may generate instructions regarding the placement, partitioning, and layout of the data in the memory circuitry.

The runtime processor 692 is operatively coupled to the reconfigurable processor circuits 695 via an interface. If desired, the interface may be a PCIe interface or any other interface that enables the runtime processor 692 to exchange data with the reconfigurable processor circuits 695. The runtime processor 692 is also coupled to memory circuitry (e.g., to RP memory 697).

The runtime processor 692 receives the configuration files 682 from the compiler 672 and uses the configuration files 682 for resource allocation, memory mapping, and execution of the bit files for the applications 668 on the reconfigurable processors 695. For example, the runtime processor 692 receives a first configuration file 682 of an application 668 that includes a prefill phase of an LLM inference and a second configuration file 682 of an application 668 that includes a decode phase of an LLM inference. In some technologies, the application 668 may include the LLM inference, and the prefill phase and the decode phase may be associated with different processing graphs 670 of the same application LLM inference.

The runtime processor 692 parses the configuration files 682. The configuration files 682 include configurations of the virtual data flow resources that are required to execute the user applications 668. The runtime processor 692 configures reconfigurable processor circuitry in the reconfigurable processors 695 according to the configurations. In the example above, the runtime processor 692 configures a first pool of reconfigurable processor circuitry in the reconfigurable processors 695 according to a prefill phase of an LLM inference. For example, after configuration, the first pool of reconfigurable processor circuitry is configured to access first memory circuitry (e.g., RP memory 697) to store the KV-cache in the first memory circuitry 697.

In some implementations, upon storing the KV-cache in the first memory circuitry, the first pool of reconfigurable processor circuitry can be configured to trigger a direct memory access (DMA) transfer of the KV-cache from the first memory circuitry to second memory circuitry that is associated with a second pool of reconfigurable processor circuitry.

The runtime processor 692 configures the second pool of reconfigurable processor circuitry in the reconfigurable processors 695 according to a decode phase of the LLM inference. For example, after configuration, the second pool of reconfigurable processor circuitry is configured to access the second memory circuitry (e.g., RP memory 697) to retrieve the KV-cache that was previously generated by the prefill phase of the LLM inference.

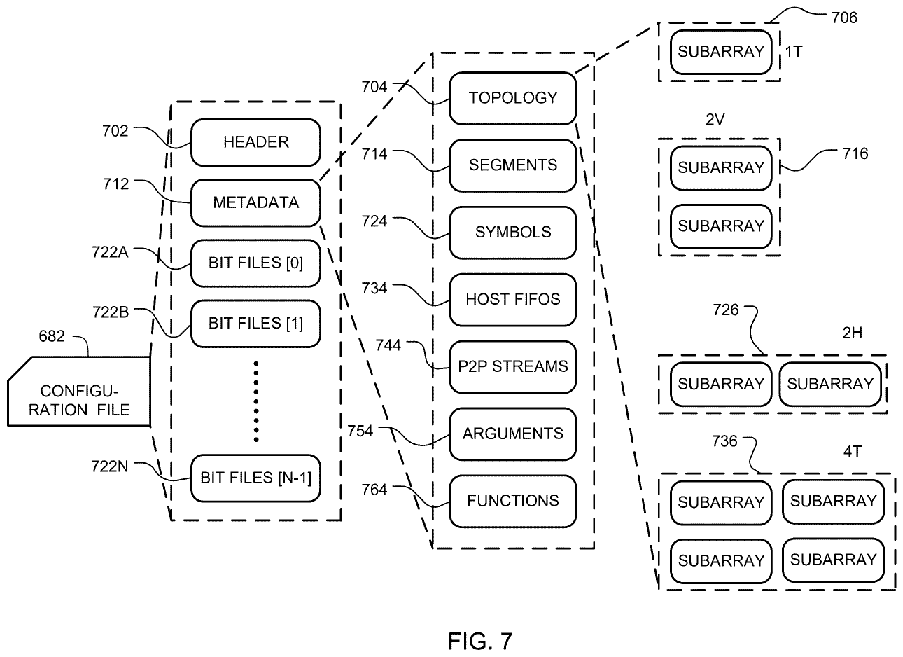

As further illustrated with respect to FIG. 7, the configuration file 682 for the prefill phase may include a first bit file 722 and first metadata 712, which may include a first argument table 754. The configuration file 682 for the decode phase may include a second bit file 722 and second metadata 712, which may include a second argument table 754. The runtime processor 692 may store the two configuration files 682 in the first and second memory circuitries, respectively. For configuring the first pool of reconfigurable processor circuitry in the reconfigurable processor circuits 695 for the prefill phase, the first pool of reconfigurable processor circuitry may load the first bit file 722 and the first argument table 754 from the first memory circuitry 697, and override first predetermined numerical constants in the first bit file 722 with corresponding values from the first argument table 754. Illustratively, the first predetermined numerical constants in the first bit file 722 comprise at least a first virtual address associated with a physical address in the first memory circuitry such as RP memory 697. For configuring the second pool of reconfigurable processor circuitry in the reconfigurable processor circuits 695 for the decode phase, the second pool of reconfigurable processor circuitry may load the second bit file 722 and the second argument table 754 from the second memory circuitry, and override second predetermined numerical constants in the second bit file 722 with corresponding values from the second argument table 754. Illustratively, the second predetermined numerical constants in the second bit file 722 comprise at least a second virtual address associated with the physical address in the second memory circuitry such as RP memory 697, whereby the first memory circuitry 697 stores data from the KV-cache generated during the prefill phase at the physical address, and a DMA engine transfers the data from the KV-cache from the first memory circuitry to the second memory circuitry.

In some scenarios, the first pool of reconfigurable processor circuitry that is configured for implementing the prefill phase comprises first programmable compute units (e.g., PCUs 520 of FIG. 5), first programmable memory units (e.g., PMUs 510 of FIG. 5), and first programmable interconnections (e.g., switch units 403 and interconnects 421, 422 of FIG. 4) between the first programmable compute units and the first programmable memory units. The second pool of reconfigurable processor circuitry that is configured for implementing the decode phase comprises second programmable compute units, second programmable memory units, and second programmable interconnections between the second programmable compute units and the second programmable memory units.

In these scenarios, the runtime processor 692 may be configured to program first programmable compute units, first programmable memory units, and first programmable interconnections in the first pool of reconfigurable processor circuitry using the first bit file 722 and the first argument table 754. If desired, the runtime processor 692 may be configured to program second programmable compute units, second programmable memory units, and second programmable interconnections in the second pool of reconfigurable processor circuitry using the second bit file and the second argument table 754. Thereby, the first and second pools of reconfigurable processor circuitry and the first and second memory circuitry are separate from each other. Illustratively, the first and second memory circuitry are configured according to the same physical layout, and a direct memory access (DMA) transfer engine transfers data from the first memory circuitry to the second memory circuitry over a network such that the KV-cache is transferred from the first pool of reconfigurable processor circuitry to the second pool of reconfigurable processor circuitry.

Illustratively, the runtime processor 692 may be configured to identify a first set of symbols (e.g., symbols 724 of FIG. 7) having a first number of symbols in first metadata (e.g., metadata 712 of FIG. 7) of the configuration file 682 for the prefill phase, whereby each symbol in the first set of symbols is associated with a different entry of the KV-cache. By way of example, the runtime processor 692 may be configured to identify a second set of symbols having a second number of symbols in second metadata of the configuration file 682 for the decode phase, and each symbol in the second set of symbols is associated with the same respective entry of the KV-cache.

In some implementations, the runtime processor 692 implements the prefill phase in virtual machine VM1 that is allocated the first pool of reconfigurable processor circuitry and implements the decode phase in virtual machine VM2 that is allocated the second pool of reconfigurable processor circuitry. Virtual machine VM1 includes a first set of CGR units, which can include some or all CGR units of a single reconfigurable processor circuit or of multiple reconfigurable processor circuits, along with associated bus and first memory circuitry (e.g., PCIe channels, DMA channels, DDR channels, DRAM memory, HBM). Virtual machine VM2 includes a second set of CGR units, which can include some or all CGR units of a single reconfigurable processor circuit or of multiple reconfigurable processor circuits, along with associated bus and second memory circuitry (e.g., PCIe channels, DMA channels, DDR channels, DRAM memory, HBM).

The runtime processor 692 respects the topology information (e.g., topology information 704 of FIG. 7) in the configuration files 682 when allocating CGR units to the virtual data flow resources requested in the configuration files 682. For example, consider the scenario in which the reconfigurable processor has a non-uniform communication bandwidth in East/West directions versus North/South directions. In this scenario, a virtual tile geometry that requires, for example, two tiles arranged horizontally, may suffer in performance if mapped to a physical tile geometry in which two tiles are arranged vertically. In some implementations, the topology information may specify rectilinear tile geometries.

The runtime processor 692 may then start execution of the LLM inference application 668 on the reconfigurable processor circuitry. For example, the runtime processor 692 may configure the first pool of reconfigurable processor circuitry of reconfigurable processors 695 and associated first memory circuitry 697 to implement the prefill phase and the second pool of reconfigurable processor circuitry of reconfigurable processors 695 and associated second memory circuitry 697 to implement the decode phase. Illustratively, the first pool of reconfigurable processor circuitry generates entries into the KV-cache based on a prompt and stores the entries in the KV-cache in the first memory circuitry 697, and the second pool of reconfigurable processor circuitry retrieves the generated entries into the KV-cache from the second memory circuitry 697.

FIG. 6B illustrates an example data processing system 600. The data processing system 600 includes one or more host processors coupled to a storage medium, a compiler 620 executable in any of the one or more host processors, runtime processes 630 executable in any of the one or more host processors, and reconfigurable processor circuitry and associated memory circuitry 640. The compiler 620 generates configuration files for a prefill phase and a decode phase of an LLM inference with memory sharing for KV-cache transfer between the prefill phase and the decode phase of the LLM inference, whereby the configuration files configure the reconfigurable processor circuitry and associated memory circuitry 640 for implementing the prefill phase and the decode phase on separate pools of reconfigurable processor circuitry each having their own reconfigurable processor circuitry and associated memory circuitry 640.

As depicted, compiler 620 includes several stages to convert a high-level program with statements that define user algorithms and functions, e.g., algebraic expressions and functions, to configuration data in a configuration file, which is sometimes also referred to as “processor-executable file (PEF)”, for configuring reconfigurable processor circuitry and associated memory circuitry 640 according to a configuration. A high-level program may include source code written in programming languages like C, C++, Java, JavaScript, Python, and/or Spatial, for example. In some implementations, the high-level program may include statements that invoke various PyTorch functions.

Compiler 620 may receive its input from application platform 610, or any other source of high-level program statements suitable for parallel processing, which provides a user interface for general users. If desired, the compiler 620 may further receive hardware description 615, for example defining the physical units in the reconfigurable processor circuitry. Application platform 610 may include libraries such as PyTorch, TensorFlow, ONNX, Caffe, and Keras to provide user-selected and configured algorithms.

Application platform 610 outputs a high-level program to compiler 620, which in turn outputs a configuration file that is executed in runtime processes 630 using reconfigurable processor circuitry and associated memory circuitry 640.

Compiler 620 may include dataflow graph compiler 621, which may handle a dataflow graph, algebraic graph compiler 622, template graph compiler 623, template library 624, placer and router PNR 625, and KV-cache compatibility compiler 627. In some implementations, template library 624 includes RDU abstract intermediate language (RAIL) and/or assembly language interfaces for power users.

Dataflow graph compiler 621 converts the high-level program with user algorithms and functions from application platform 610 to one or more dataflow graphs. The high-level program may be suitable for parallel processing, and therefore parts of the nodes of the dataflow graphs may be intrinsically parallel unless an edge in the graph indicates a dependency. Dataflow graph compiler 621 may provide code optimization steps like false data dependency elimination, dead-code elimination, and constant folding. The dataflow graphs encode the data and control dependencies of the high-level program.

Dataflow graph compiler 621 may support programming reconfigurable processor circuitry and associated memory circuitry 640 at higher or lower-level programming languages, for example from an application platform 610 to C++and assembly language. In some implementations, dataflow graph compiler 621 allows programmers to provide code that runs directly on the reconfigurable processor circuitry and associated memory circuitry 640. In other implementations, dataflow graph compiler 621 provides one or more libraries that include predefined functions like linear algebra operations, element-wise tensor operations, non-linearities, and reductions required for creating, executing, and profiling the dataflow graphs on the reconfigurable processor circuitry and associated memory circuitry 640. Dataflow graph compiler 621 may provide an application programming interface (API) to enhance functionality available via the application platform 610. As shown in FIG. 6B, dataflow graph compiler 621 outputs a dataflow graph that is received by algebraic graph compiler 622.

Algebraic graph compiler 622 may include a model analyzer and compiler (MAC) level that makes high-level mapping decisions for (subgraphs of the) dataflow graph based on hardware constraints. In some implementations, the algebraic graph compiler 622 may support various application frontends such as Samba, JAX, and TensorFlow/HLO. If desired, the algebraic graph compiler 622 may transform the graphs via autodiff and GradNorm, perform stitching between subgraphs, interface with template generators for performance and latency estimation, convert dataflow graph operations to arithmetic or algebraic intermediate representation (AIR) operations, perform tiling, sharding (i.e., data partitioning, for example for storing in memory circuitry) and other operations, and model or estimate the parallelism that can be achieved on the dataflow graph.

Algebraic graph compiler 622 may further include an arithmetic or algebraic intermediate representation (AIR) level that translates high-level graph and mapping decisions provided by the MAC level into explicit AIR/Tensor statements and one or more corresponding algebraic graphs. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

Thus, algebraic graph compiler 622 replaces the user program statements of a dataflow graph by AIR/Tensor statements of an AIR/Tensor computation graph (AIR graph). As shown in FIG. 6B, algebraic graph compiler 622 provides the AIR graph to template graph compiler 623.

Template graph compiler 623 may translate AIR/Tensor statements of an AIR graph into template library intermediate representation (TLIR) statements of a TLIR graph, optimizing for the target hardware architecture into unplaced variable-sized units (referred to as logical CGR units or reconfigurable processor circuitry) suitable for PNR 625. Such a TLIR graph is sometimes also referred to as an “operation unit graph” and the unplaced-variable-sized units as “logical units” or “nodes”. So-called “Logical edges” or simply “edges” in the operation unit graph may couple the logical units.

Template graph compiler 623 may allocate metapipelines for sections of the template dataflow statements and corresponding sections of unstitched template computation graph. Template graph compiler 623 may add further information (e.g., name, inputs, input names and dataflow description) for PNR 625 and make the graph physically realizable through each performed step. For example, template graph compiler 623 may provide translation of AIR graphs to specific model operation templates such as for general matrix multiplication (GeMM). An implementation may convert part or all intermediate representation operations to templates, which are sometimes also referred to as “template nodes”, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units, which are commonly referred to as logical units, with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 624 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

In some implementations, the assembler may generate assembler code for a logical unit, whereby the assembler code is associated with a data operation that is to be executed by the logical unit. The logical units of an operation unit graph may include (e.g., store) the assembler code that is associated with the respective data operations of the respective logical units, if desired.

The template graph compiler 623 may also determine control signals, as well as control gates that are required to enable the CGR units (whether logical or physical) to coordinate dataflow between the CGR units in the CGR array of a CGR processor.

As shown in FIG. 6B, compiler 620 may include a KV-cache compatibility compiler 627. The KV-cache compatibility compiler 627 enables the transfer of the KV-cache via by storing the data according to a predetermined physical layout in the associated memory circuitry in a first configuration file and retrieving the data according to the predetermined physical layout from the associated memory circuitry in a second configuration file. For example, the KV-cache compatibility compiler 627 generates the two configuration files such that the output data and the input data are identical and laid out the same way in physical memory

Thus, the outputs generated by a first pool of reconfigurable processor circuitry of reconfigurable processor circuitry and associated memory circuitry 640 that is configured by a first configuration file according to a first configuration (e.g., a prefill phase of an LLM inference) can be passed to a second pool of reconfigurable processor circuitry of the reconfigurable processor circuitry and associated memory circuitry 640 that is configured by a second configuration file according to a second configuration (e.g., a decode phase of an LLM inference).

Illustratively, the KV-cache compatibility compiler 627 of compiler 620 receives a first configuration file (e.g., compatible configuration file (PEF) for KV-cache transfer 628) for configuring a first pool of reconfigurable processor circuitry in the reconfigurable processor circuitry and associated memory circuitry 640 for generating a first token and keys and values of a KV-cache based on first input data (e.g., a prompt) during a prefill phase of an LLM inference. The first configuration file includes instructions for storing output data related to the keys and values of the KV-cache generated during the prefill phase in the associated memory circuitry according to a predetermined physical layout in the associated memory. If desired, the first configuration file includes instructions to partition the token (and the keys and values of the KV-cache) into data partitions and to store the data partitions according to the predetermined physical layout in the associated memory circuitry.

The KV-cache compatibility compiler 627 of compiler 620 generates instructions for configuring a second pool of reconfigurable processor circuitry in the reconfigurable processor circuitry and the associated memory circuitry 640 according to a decode phase of an LLM inference. In particular, the KV-cache compatibility compiler 627 generates instructions for retrieving the first token and keys and values of the KV-cache that are stored in the associated memory circuitry according to the predetermined physical layout, and for configuring the second pool of reconfigurable processor circuitry to implement the decode phase of the LLM inference and to generate output tokens based on the first token and the keys and values of the KV-cache. If desired, the second configuration file includes instructions to retrieve the data partitions according to the predetermined physical layout from the memory circuitry and to form the token from the data partitions.

In some implementations, the KV-cache compatibility compiler 627 of compiler 620 may also receive a partitioning of the keys and values of the KV-cache into data partitions 629. In some scenarios, the partitioning of the keys and values of the KV-cache into data partitions 629 may be specified by a user. In these scenarios, the user is responsible for specifying the same partitioning of the keys and values of the KV-cache into data partitions during generation of the configuration file for the prefill phase and during generation of the configuration file for the decode phase. In other scenarios, the compiler 620 may generate a partitioning of the keys and values of the KV-cache into the data partitions when generating the configuration file for the prefill phase and use this partitioning of the keys and values of the KV-cache into the data partitions when generating the configuration file for the decode phase.

Upon receiving a partitioning of the keys and values of the KV-cache into data partitions 629, for generating the configuration file for the decode phase such that the configuration file is adapted for using the keys and values of the KV-cache generated during execution of the prefill phase and stored in the associated memory circuitry according to the predetermined physical layout, the KV-cache compatibility compiler 627 is configured to identify a first set of symbols having a first number of symbols with a first grouping of symbols, whereby the first set of symbols is embedded in first metadata of the configuration file for the prefill phase. Illustrative elements of a configuration file generated by compiler 620 including metadata, arguments, and symbols are described with reference to FIG. 7. By way of example, each symbol in the first set of symbols is associated with a different data partition of the data partitions. If desired, the KV-cache compatibility compiler 627 of compiler 620 may generate second metadata in the configuration file for the decode phase including a second set of symbols having a second number of symbols, whereby each symbol in the second set of symbols is associated with another different data partition of the data partitions, and the second number of symbols is equal to the first number of symbols.

Illustratively, the KV-cache compatibility compiler 627 may, for each symbol in the second set of symbols, associate the symbol with a corresponding symbol in the first set of symbols such that the symbol in the second set of symbols is associated with a same data partition of the data partitions as the corresponding symbol in the first set of symbols.

If desired, the KV-cache compatibility compiler 627 may raise an error in response to detecting that one of the symbols in the second set of symbols fails to be associated with a corresponding symbol in the first set of symbols.

In some implementations, the configuration file for the prefill phase includes for each data partition of the data partitions a respective order of storing elements of the data partition in the associated memory circuitry. In these implementations, the KV-cache compatibility compiler 627 of compiler 620 may be configured to generate in the second configuration file for each data partition of the data partitions a same respective order of storing the elements of the data partition in the associated memory circuitry as in the configuration file for the prefill phase.

By way of example, the compiler may be configured to group symbols in the second set of symbols by replicating the first grouping of symbols in the first set of symbols.

PNR 625 translates and maps logical (i.e., unplaced physically realizable) units (e.g., the nodes of the operation unit graph) and edges (e.g., the edges of the operation unit graph) to a physical layout of reconfigurable processor circuits, e.g., a physical array of CGR units in a semiconductor chip. PNR 625 also determines physical data channels, which are sometimes also referred to as “physical links”, to enable communication among the CGR units and between the CGR units and circuits coupled via the TLN or the ALN; allocates ports on the CGR units and switches; provides configuration data and initialization data for the target hardware; and produces configuration files, e.g., processor-executable format (PEF) files.

If desired, PNR 625 may provide bandwidth calculations, allocate network interfaces such as AGCUs and virtual address generators (VAGs), provide configuration data that allows AGCUs and/or VAGs to perform address translation, and control ALN switches and data routing. PNR 625 may provide its functionality in multiple steps and may include multiple modules (not shown in FIG. 6B) to provide the multiple steps, e.g., a placer, a router, a port allocator, and a PEF file generator.

Illustratively, PNR 625 may receive its input data in various ways. For example, it may receive parts of its input data from any of the earlier modules (e.g., dataflow graph compiler 621, algebraic graph compiler 622, template graph compiler 623, template library 624 and/or KV-cache compatibility compiler 627). In some implementations, an earlier module, such as KV-cache compatibility compiler 627, may have the task of preparing all information for PNR 625 and no other units provide PNR input data directly.

Further implementations of compiler 620 provide for an iterative process, for example by feeding information from PNR 625 back to an earlier module (e.g., to algebraic graph compiler 622). For example, in some implementations, the earlier module may execute a new compilation step in which it uses physically realized results rather than estimates of cost estimation tool 645 or placeholders for physically realizable circuits. As shown in FIG. 6B, PNR 625 may feed information regarding the physically realized circuits back to algebraic graph compiler 622.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 620 binds memory allocations to unplaced memory units and binds operations specified by operation nodes in the dataflow graph to unplaced compute units, and these bindings may be specified in the configuration data. In some implementations, compiler 620 partitions parts of a dataflow graph into memory subgraphs and compute subgraphs, and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 620 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

FIG. 7 illustrates an example configuration file 682. As described above, the configuration file 682 include bit files 722a, 722b, . . . 722n that implement the processing graphs 670 of the user applications 668 using the reconfigurable processor circuitry in the reconfigurable processor circuits 695 of FIG. 6A.

A program executable contains a bit-stream representing the initial configuration, or starting state, of the physical reconfigurable processor circuitry that executes the program. This bit-stream is referred to as a bit file. The configuration file 682 includes header 702 that indicates destinations on the reconfigurable processor circuitry for configuration data in the bit files. In some implementations, a plurality of bit files is generated for a single application.

The configuration files can include a sequence of bit file-argument table pairs. The argument tables are configured as appropriate, and when runtime configures the reconfigurable processor circuitry in the reconfigurable processor circuits, runtime executes each bit file in the appropriate sequence.

Each operation may have a unique argument table. Bit files may be shared across multiple operations, if desired.

Illustratively, the argument table and the bit files may be stored in memory circuitry. As an example, a host processor (e.g., host processor 180 of FIG. 1) may store the argument table and the bit files in HBM. As another example, the host processor may store the argument tables and the bit files in DDR memory.

In some implementations, upon a program load, the reconfigurable processor circuitry may override the arguments in the bit files with values from the argument table on the fly when configuring the reconfigurable processor circuitry. In other words, the reconfigurable processor circuitry loads both the bit file and the argument table, and the loaded programming includes the configuration from the bit file modified in accordance with the argument table. Note that as part of this loading process, neither the argument table nor the bit file are modified in the memory circuitry (e.g., in HBM). In other implementations, the runtime processor may modify the bit file in accordance with the argument table and configure the reconfigurable processor circuitry in the reconfigurable processor circuits with the modified bit file.

Illustratively, the configuration file 682 includes metadata 712 that accompanies the bit files and specifies configurations of virtual data flow resources required to execute the applications (e.g., applications 668 of FIG. 6A). In one example, the configuration file 682 can specify that a particular application needs an entire reconfigurable processor for execution, and as a result the metadata 712 identifies virtual data flow resources equaling at least the entire reconfigurable processor for loading and executing the bit files for the particular application. In another example, the configuration file 682 can specify that a particular application needs one or more portions of a reconfigurable processor for execution, and as a result the metadata 712 identifies virtual data flow resources equaling at least the one or more portions of the reconfigurable processor for loading and executing the bit files for the particular application. In yet another example, the configuration file 682 can specify that a particular application needs two or more reconfigurable processors for execution, and as a result the metadata 712 identifies virtual data flow resources equaling at least the two or more reconfigurable processors for loading and executing the bit files for the particular application. In yet another example, the configuration file 682 can specify that a particular application needs an entire first reconfigurable processor and one or more portions of a second reconfigurable processor for execution, and as a result the metadata 712 identifies virtual data flow resources equaling at least the first reconfigurable processor and the one or more portions of the second reconfigurable processor for loading and executing the bit files for the particular application.

One skilled in the art would appreciate that the configuration file 682 can similarly specify reconfigurable processors or portions thereof spanning across racks, pods, superpods, and zones in a data center, and as a result the metadata 712 identifies virtual data flow resources spanning across the racks, pods, superpods, and zones in the data center for loading and executing the bit files for the particular application.

As part of the metadata 712, the configuration file 682 includes topology information 704 that specifies orientation or shapes of portions of a reconfigurable processor required to load and execute the bit files for a particular application. A reconfigurable processor circuit may include reconfigurable processor circuitry that is arranged in one or more arrays of CGR units (e.g., CGR processor 110 of FIG. 1 may include arrays of CGR units 120) in a programmable interconnect fabric (e.g., array-level network ALN of FIG. 1). If desired, an array of CGR units may include compute units and/or memory units. The arrays of CGR units in the reconfigurable processor circuits (e.g., reconfigurable processors 695 of FIG. 6A) may be partitionable into two or more subsets of arrays of CGR units. A subset is a set (or grid) of arrays of CGR units and covers at least a portion of the arrays of CGR units in the reconfigurable processor circuits. Illustratively, a reconfigurable processor circuit may include a plurality of tiles, whereby a tile is a portion of the arrays of CGR units with a certain number of CGR units.

In one implementation, reconfigurable processor circuitry comprises a plurality of tiles of configurable units, for example, four tiles that form an array of CGR units in a reconfigurable processor circuit. The topology information 704 specifies an orientation of tiles in the plurality of tiles required to load and execute the bit files for a particular application.

For example, when the particular application is allocated two tiles of the reconfigurable processor circuit, the topology information 704 specifies whether the two tiles are arranged in a vertical orientation (2V) 716 or a horizontal orientation (2H) 726. The topology information 704 can also allocate a single tile (1T) 706 of the reconfigurable processor circuit to the particular application. The topology information 704 can also allocate four tiles (4T) 736 of the reconfigurable processor circuit to the particular application. In other implementations, other geometries may be specified, such as a group of three tiles.

The configuration file 682 also specifies virtual data flow resources like PCIe channels, DMA channels, and DDR channels required to load and execute the bit files for a particular application. The configuration file 682 also specifies virtual data flow resources like main memory (e.g., off-chip/external DRAM), local secondary storage (e.g., local disks (e.g., HDD, SSD)), remote secondary storage (e.g., distributed file systems, web servers), latches, registers, and caches (e.g., SRAM) required to load and execute the bit files for a particular application.

The configuration file 682 also specifies virtual memory segments 714 for the requested virtual data flow resources, including virtual address spaces of the virtual memory segments and sizes of the virtual address spaces. The configuration file 682 also specifies symbols 724 (e.g., tensors, streams) required to load and execute the bit files for a particular application. The configuration file 682 also specifies HOST FIFOs 734 accessed by the bit files for a particular application during execution. The configuration file 682 also specifies peer-to-peer (P2P) streams 744 (e.g., data flow exchanges and control token exchanges between sources and sinks) exchanged between configurable units on which the bit files for a particular application are loaded and executed. The configuration file 682 also specifies arguments 754 that modify execution logic of a particular application by supplying additional parameters or new parameter values to the bit files for the particular application. The configuration file 682 also specifies functions 764 (e.g., data access functions like transpose, alignment, padding) to be performed by the configurable units on which the bit files for a particular application are loaded and executed.

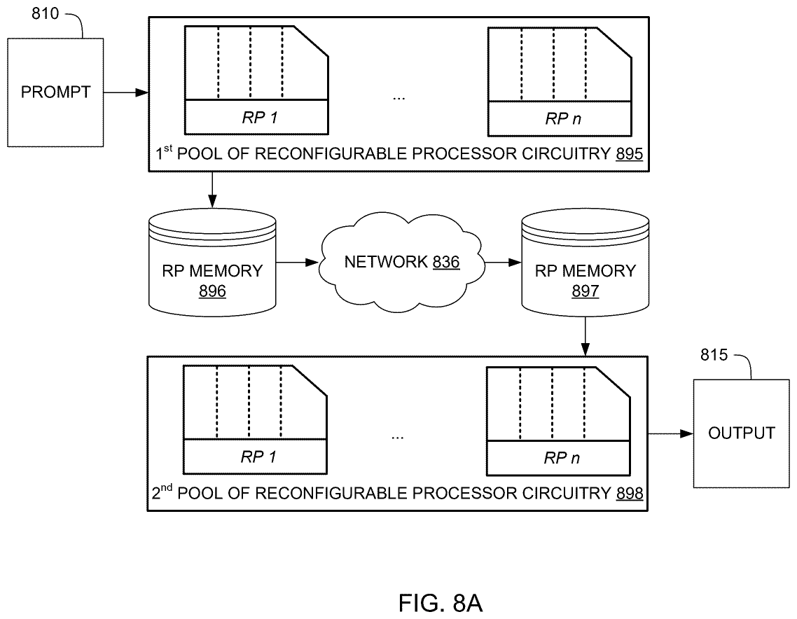

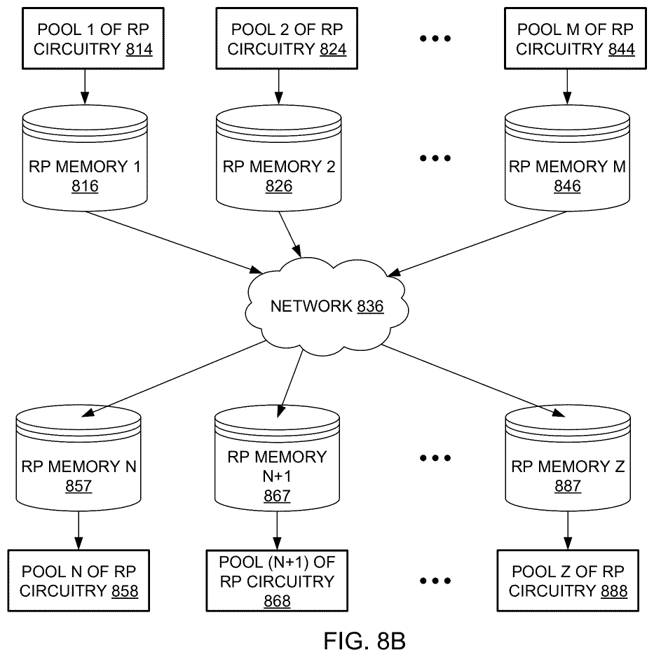

FIG. 8A illustrates a disaggregated implementation of LLM inference on reconfigurable processor circuitry, in which the prefill phase of the LLM inference is implemented using a first pool of reconfigurable processor circuitry 895 with first memory circuitry 896, and the decode phase of the LLM inference is implemented using a second pool of reconfigurable processor circuitry 898 with second memory circuitry 897.

The first pool of reconfigurable processor circuitry 895 can be configured to implement techniques that improve a time-to-first-token (TTFT) including the prepacking of input sequences, speculative decoding, chunked prefill, quantization, and/or token pruning. The second pool of reconfigurable processor circuitry 898 can be configured to implement techniques that improve time-per-output-token (TPOT) including efficient batching such as continuous batching or dynamic batching and/or attention mechanism optimization such as fusing attention computations into a single kernel.

The first token and the keys and values of the KV cache generated in response to a prompt 810 during the prefill phase in the first pool of reconfigurable processor circuitry 895 are stored in RP memory 896 according to a predetermined physical layout. For example, the first pool of reconfigurable processor circuitry 895 can store the first token and the keys and values of the KV cache in a predetermined order in RP memory 896.

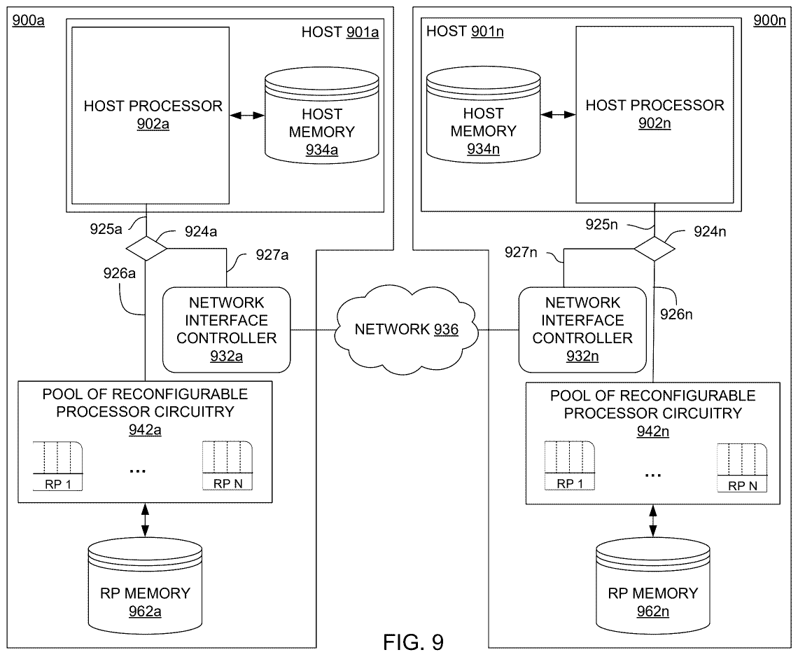

A direct memory access (DMA) transfer engine transfers the first token and the keys and values of the KV cache that are stored in RP memory 896 over network 836 to RP memory 897. In some implementations, the DMA transfer engine may be part of a host (e.g., host 180 of FIG. 1 or host 901a of FIG. 9). In these implementations, the host configures the DMA transfer engine to read the data including the first token and the keys and values of the KV cache from RP memory 896 and sends the data via the network to RP memory 897 where the data is stored in RP memory 897 according to the predetermined physical layout. In other implementations, the first pool of reconfigurable processor circuitry 895 can initiate the DMA transfer of the first token and the keys and values of the KV cache from RP memory 896 to RP memory 897. For example, after the first pool of reconfigurable processor circuitry 895 finishes writing data to RP memory 896, the first pool of reconfigurable processor circuitry 895 can initiate the DMA transfer.

Examples of the network 836 include a Storage Area Network (SAN), a Local Area Network (LAN), and a Wide Area Network (WAN). The SAN can be implemented with a variety of data communications fabrics, devices, and protocols. For example, the fabrics for the SAN can include Fibre Channel, Ethernet, InfiniBand™, Serial Attached Small Computer System Interface (‘SAS’), or the like. Data communication protocols for use with the SAN can include Advanced Technology Attachment (‘ATA’), Fibre Channel Protocol, Small Computer System Interface (‘SCSI’), Internet Small Computer System Interface (‘iSCSI’), HyperSCSI, Non-Volatile Memory Express (‘NVMe’) over Fabrics, or the like.

The LAN can also be implemented with a variety of fabrics, devices, and protocols. For example, the fabrics for the LAN can include Ethernet (e.g., 802.3), wireless (e.g., 802.11), or the like. Data communication protocols for use in the LAN can include Transmission Control Protocol (‘TCP’), User Datagram Protocol (‘UDP’), Internet Protocol (IP), Hypertext Transfer Protocol (‘HTTP’), Wireless Access Protocol (‘WAP’), Handheld Device Transport Protocol (‘HDTP’), Session Initiation Protocol (‘SIP’), Real-time Transport Protocol (‘RTP’), or the like.

The second pool of reconfigurable processor circuitry 898 retrieves the data including the first token and the keys and values of the KV cache according to the predetermined physical layout from RP memory 897 and generates an output 815 based on the token and the keys and values of the KV cache. In the scenario in which the first pool of reconfigurable processor circuitry 895 has stored the first token and the keys and values of the KV cache in a predetermined order in RP memory 896., the second pool of reconfigurable processor circuitry 898 can retrieve the first token and the keys and values of the KV cache in the same predetermined order from RP memory 897.

Illustratively, the first pool of reconfigurable processor circuitry is configured such that the first token and the keys and values of the KV cache generated during the prefill phase have the same placement, sharding, memory layout, and addresses the same physical regions in RP memory 896 as the first token and keys and values of the KV cache that the decode phase retrieves from the same physical regions in RP memory 897.

Consider the scenario in which, a first configuration file for the prefill phase (i.e., a configuration file for implementing a prefill phase of an LLM inference in the first pool of reconfigurable processor circuitry 895) includes a first bit file and a first argument table, and a second configuration file for the decode phase (i.e., a configuration file for implementing a decode phase of an LLM inference in the second pool of reconfigurable processor circuitry 898) includes a second bit file and a second argument table. Consider further that the first and second configuration files are stored in RP memory 896 and RP memory 897, respectively, and that a DMA transfer engine is configured to transfer data from RP memory 896 to RP memory 897 over network 836.

In these scenarios, the first pool of reconfigurable processor circuitry may load the first bit file and the first argument table from reconfigurable processor memory (e.g., RP memory 896) and override first predetermined numerical constants in the first bit file with corresponding values from the first argument table. Illustratively, the first predetermined numerical constants in the first bit file include at least a first virtual address that is associated with a first physical address in RP memory 896. For example, the configuration file 682 of FIG. 7 includes bit file 722A and arguments 754 in metadata 712. The bit file and the arguments may be stored in reconfigurable processor memory, and the first pool of reconfigurable processor circuitry 895 may load the bit file 722A and arguments 754 from the reconfigurable processor memory and override predetermined numerical constants in the bit file 722A with corresponding values from the arguments 754.

If desired, the second pool of reconfigurable processor circuitry 898 may load the second bit file and the second argument table from reconfigurable processor memory (e.g., RP memory 897) and override second predetermined numerical constants in the second bit file with corresponding values from the second argument table, whereby the second predetermined numerical constants in the second bit file include at least a second virtual address that is associated with a second physical address in RP memory 897, whereby the first token and each key and value of the KV-cache are stored at the same physical addresses in the first RP memory 896 as in the second RP memory 897.

Consider the scenario in which, the first pool of reconfigurable processor circuitry 895 includes first programmable compute units, first programmable memory units, and first programmable interconnections between the first programmable compute units and the first programmable memory units. Consider further that the second pool of reconfigurable processor circuitry 898 includes second programmable compute units, second programmable memory units, and second programmable interconnections between the second programmable compute units and the second programmable memory units. In this scenario, the data processing system 660 of FIG. 6 may program first programmable compute units, first programmable memory units, and first programmable interconnections in the first pool of reconfigurable processor circuitry 895 using the first bit file and the first argument table, and program second programmable compute units, second programmable memory units, and second programmable interconnections in the second pool of reconfigurable processor circuitry 898 using the second bit file and the second argument table.

FIG. 8B illustrates an example implementation of an LLM inference with a prefill phase implemented in several pools of reconfigurable processor circuitry 814, 824, . . . , 844 with respective associated reconfigurable processor memory 816, 826, . . . , 846, a decode phase implemented in several other pools of reconfigurable processor circuitry 858, 868, . . . , 888 with other respective associated reconfigurable processor memory 857, 867, . . . , 887, and a network 836 that couples the reconfigurable processor memories. The network 836 can be a SAN or a LAN such as the network 836 of FIG. 8A.

Illustratively, the prefill phase may be implemented in a same number of pools of reconfigurable processor circuitry as the decode phase. If desired, the prefill phase may be implemented in a different number of pools of reconfigurable processor circuitry than the decode phase. As an example, the number of pools of reconfigurable processor circuitry that implement the prefill phase may be greater than the number of pools of reconfigurable processor circuitry that implement the decode phase. As another example, the number of pools of reconfigurable processor circuitry that implement the prefill phase may be smaller than the number of pools of reconfigurable processor circuitry that implement the decode phase.

The different pools of reconfigurable processor circuitry 814, 824, . . . , 844 that implement the prefill phase generate keys and values of the KV cache and store these keys and values in the respective reconfigurable processor memory 816, 826, . . . , 846 according to a predetermined physical layout. For example, pool 1 of RP circuitry 814 generates first keys and values and stores the generated first keys and values in RP memory 1 816, pool 2 of RP circuitry 824 generates second keys and values and stores the second generated keys and values in RP memory 2 826, . . . , and pool M of RP circuitry 844 generates M^{th} keys and values and stores the M^{th} keys and values in RP memory M 846. As mentioned above, the keys and values are stored in the respective reconfigurable processor memory 816, 826, . . . , 846 according to a predetermined physical layout. For example, the keys and values are stored in the respective reconfigurable processor memory 816, 826, . . . , 846 according to a predetermined placement, sharding, and/or layout, and/or at the same physical addresses in the respective reconfigurable processor memory 816, 826, . . . , 846.

A direct memory access (DMA) transfer engine transfers the keys and values of the KV cache that are stored in the respective RP memory 816, 826, . . . , 846 over network 836 to RP memories 857, 867, . . . , 887 that are associated with the other pools of reconfigurable processor circuitry 858, 868, . . . , 888.

Illustratively, the DMA transfer engine may be part of a host (e.g., host 180 of FIG. 1 or host 901a of FIG. 9). By way of example, the host configures the DMA transfer engine to read the data including the keys and values of the KV cache from RP memory 1 816, RP memory 2 826, . . . , RP Memory M 846 and to send the data via the network 836 to RP memory N 857, RP memory (N+1) 867, . . . , RP memory Z 887 where the data is stored according to the predetermined physical layout.

Consider the scenario in which one of the pools of RP circuitry of the prefill phase has generated an entry of the KV cache and stored the entry of the KV cache in the associated RP memory. Upon storage of the entry of the KV cache in the associated RP memory, the pool of RP circuitry can notify the DMA transfer engine that the entry of the KV cache is available. Another one of the pools of RP circuitry of the decode phase can inform the DMA transfer engine as soon as an open slot in the other one of the pools of RP circuitry is open. Upon receiving both, the notification of availability of the entry of the KV cache from the pool of RP circuitry that implements the prefill phase and the notification of an open slot from the pool of RP circuitry that implements the decode phase, the DMA transfer engine can initiate the transfer of the entry of the KV cache between the respective associated RP memories.

For example, pool 2 of RP circuitry 824 has generated an entry of the KV cache, stored the entry of the KV cache according to a predetermined physical layout in RP memory 826, and notified the DMA transfer engine that the entry of the KV cache is available. Pool Z of RP circuitry 888 has notified the DMA transfer engine of a slot that is open for processing. As a result, the DMA transfer engine transfers the entry of the KV cache from RP memory 2 826 to RP memory Z 887 over network 836. Thereby, the entry of the KV cache is stored in RP memory Z 887 according to the same physical layout as the entry of the KV cache was previously stored in RP memory 2 826.

FIG. 9 is a diagram of an illustrative data processing system including two sub-systems 900a, 900n, each having a pool of reconfigurable processor circuitry 942a, 942n that are coupled by a network 936 (also called herein “network fabric”). The network 936 can be a SAN or a LAN such as network 836 of FIG. 8B.

The first sub-system 900a includes a first pool of reconfigurable processor circuitry 942a with a first reconfigurable processor memory 962a, a first host 901a that is operatively coupled to the first pool of reconfigurable processor circuitry 942a, and a first network interface controller (NIC) 932a that is sometimes also referred to as a “network interface card” 932a.

The second sub-system 900n includes a second pool of reconfigurable processor circuitry 942n with a second reconfigurable processor memory 962n, a second host 901n that is operatively coupled to the second pool of reconfigurable processor circuitry 942n, and a second network interface controller (NIC) 932n that is sometimes also referred to as a “network interface card” 932n.

Illustratively, the network 936 may connect NIC 932a with NIC 932n, thereby connecting the first host 901a and the first pool of reconfigurable processor circuitry 942a with the second host 901n and the second pool of reconfigurable processor circuitry 942n.

The first host 901a includes a first host processor 902a and a first host memory 934a that is coupled to the first host processor 902a. In some implementations, the first host memory may be included within the first host processor. The first network interface controller (NIC) 932a is operatively coupled to the first pool of reconfigurable processor circuitry 942a and to the first host processor 902a.

The second host 901n includes a second host processor 902n and a second host memory 934n that is coupled to the second host processor 902n. In some implementations, the second host memory may be included within the second host processor. The second network interface controller (NIC) 932n is operatively coupled to the second pool of reconfigurable processor circuitry 942n and to the second host processor 902n.

In implementations described herein, the first and second host processors 902a, 902n are coupled to a respective first local bus 925a, 925n, the first and second network interface controllers (NICs) 932a, 932n are coupled to a respective second local bus 927a, 927n, and the first and second reconfigurable processors 942a, 942n are coupled to a respective third local bus 926a, 926n.

A bus switch 924a in the first sub-system 900a may couple the local buses 925a, 926a, 927a, thereby coupling the first host processor 902a, the first pool of reconfigurable processor circuitry 942a, and the first network interface controller 932a. Another bus switch 924n in the second sub-system 900n may couple the local buses 925n, 926n, 927n, thereby coupling the second host processor 902n, the second pool of reconfigurable processor circuitry 942n, and the second network interface controller 932n.

The local buses 925a, 926a, 927a, 925n, 926n, 927n may include a Peripheral Component Interconnect Express (PCIe) bus, a Cache Coherent Interconnect for Accelerators (CCIX) protocol bus, a Compute Express Link (CXL) connection, and/or an Open Coherent Accelerator Processor Interface (OpenCAPI).

In some implementations, the first sub-system 900a and/or the second sub-system 900n may include more than one first pool of reconfigurable processor circuitry 942a and/or more than one second pool of reconfigurable processor circuitry 942n. For example, the first sub-system 900a may include M pools of reconfigurable processor circuitry (e.g., as shown in FIG. 8B), where M is an integer greater than one, and/or the second sub-system 900n may include (Z-N) pools of reconfigurable processor circuitry (e.g., as shown in FIG. 8B), where (Z-N) is an integer greater than one. In some implementations, a pool of reconfigurable processor circuitry may include one or more reconfigurable processors such as RP 1 to RP n of the first and second pools of reconfigurable processor circuitry shown in FIG. 8A.

By way of example, the first and/or second pools of reconfigurable processor circuitry 942a, 942n include Coarse-Grained Reconfigurable Architecture (CGRA) devices. If desired, each pool of reconfigurable processor circuitry 942a, 942n may include an array of configurable units (e.g., compute units and memory units) in a programmable interconnect fabric. The array of configurable units in the reconfigurable processor may be partitionable into a plurality of subarrays (or tiles) of configurable units. If desired, CGR processor 110 having arrays of CGR units 120 of FIG. 1 may implement one or more reconfigurable processors of the first and/or second pool of reconfigurable processor circuitry 942a, 942n.

The first and/or second reconfigurable processor memory 962a, 962n may include main memory such as dynamic random-access memory (DRAM), flash memory, magnetic disks (e.g., hard disk drive (HDD)), solid-state drives (SSD), optical disks, and/or any other memory type known in the art.

The first and second pool of reconfigurable processor circuitry 942a, 942n may interface with the first and second reconfigurable processor memory 962a, 962n, respectively (e.g., a memory interface such as memory interface 139 of FIG. 1 may couple the first pool of reconfigurable processor circuitry 942a with the first reconfigurable processor memory 962a and another memory interface such as memory interface 139 of FIG. 1 may couple the second pool of reconfigurable processor circuitry 942n with the second reconfigurable processor memory 962n).

In some implementations, each reconfigurable processor of the first and/or second pool of reconfigurable processor circuitry 942a, 942n may interface with a respective separate reconfigurable processor memory 962a, 962n. If desired, the first and/or second reconfigurable processor memory 962a, 962n may be in the same package and/or on the same die as the associated first and/or second pool of reconfigurable processor circuitry 942a, 942n. In other implementations, a single first reconfigurable processor memory 962a may be associated with the first pool of reconfigurable processor circuitry 942a, and/or a single second reconfigurable processor memory 962n may be associated with the second pool of reconfigurable processor circuitry 942n.

The second pool of reconfigurable processor circuitry 942n of the second sub-system 900n may be configured to implement a virtual function, and the virtual function uses a virtual address for a memory access operation. Illustratively, the second host processor 902n is configured to implement an application programming interface (API) that translates the virtual address into a physical address. The second NIC 932n uses the physical address to initiate a direct memory access operation at the first reconfigurable processor memory 962a or the first host memory 934a that moves data directly between the second pool of reconfigurable processor circuitry 942n and the first reconfigurable processor memory 962a or the first host memory 934a, whereby the data bypasses the second host 901n and is transferred directly between the second pool of reconfigurable processor circuitry 942n and the second NIC 932n.

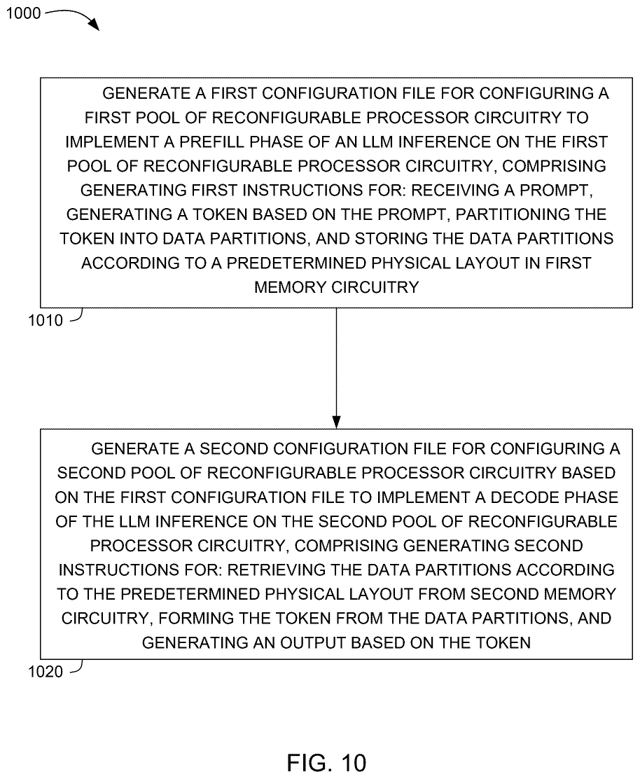

FIG. 10 is a flowchart 1000 with illustrative operations that a compiler (e.g., compiler 620) in a data processing system performs. The data processing system includes a first pool of reconfigurable processor circuitry, first memory circuitry, coupled to the first pool of reconfigurable processor circuitry, a second pool of reconfigurable processor circuitry that is different than the first pool of reconfigurable processor circuitry, second memory circuitry, that is different than the first memory circuitry and coupled to the second pool of reconfigurable processor circuitry, a direct memory access (DMA) transfer engine for transferring data from the first memory circuitry to the second memory circuitry over a network, and one or more processors coupled to a storage medium. The compiler is executable in any of the one or more processors and generates configuration files (e.g., configuration files 682 of FIG. 6A).

During operation 1010, the compiler generates a first configuration file for configuring the first pool of reconfigurable processor circuitry to implement a prefill phase of an LLM inference on the first pool of reconfigurable processor circuitry, comprising generating first instructions for: receiving a prompt, generating a token based on the prompt, partitioning the token into data partitions, and storing the data partitions according to a predetermined physical layout in the first memory circuitry.

For example, the compiler 672 of FIG. 6A generates a first configuration file 682 for configuring first pool of reconfigurable processor circuitry 895 of FIG. 8A to implement a prefill phase of an LLM inference on the first pool of reconfigurable processor circuitry 895, comprising generating first instructions for: receiving a prompt 810, generating a token based on the prompt, partitioning the token into data partitions, and storing the data partitions according to a predetermined physical layout in memory circuitry 897.

During operation 1020, the compiler generates a second configuration file for configuring the second pool of reconfigurable processor circuitry based on the first configuration file to implement a decode phase of the LLM inference on the second pool of reconfigurable processor circuitry, comprising generating second instructions for: retrieving the data partitions according to the predetermined physical layout from the second memory circuitry, forming the token from the data partitions, and generating an output based on the token.

For example, the compiler 672 of FIG. 6A generates a second configuration file 682 for configuring second pool of reconfigurable processor circuitry 898 of FIG. 8A to implement a decode phase of an LLM inference on the second pool of reconfigurable processor circuitry 898, comprising generating first instructions for: retrieving the data partitions according to the predetermined physical layout from the memory circuitry 897, forming the token from the data partitions, and generating an output 815 based on the token.

In some implementations, the compiler may write each data partition of the data partitions as a single block to the memory circuitry when storing the data partitions according to the predetermined physical layout in the memory circuitry.

If desired, the compiler may read each data partition of the data partitions as a single block from the memory circuitry when retrieving the data partitions according to the predetermined layout from the memory circuitry.

Illustratively, the compiler may identify a first set of symbols having a first number of symbols in first metadata of the first configuration file for the prefill phase, whereby each symbol in the first set of symbols is associated with a first token and/or a key or value of the KV cache generated by the first pool of reconfigurable processor circuitry (e.g., first pool of reconfigurable processor circuitry 895 of FIG. 8A) and stored in the associated memory circuitry 897 when executing the prefill phase, and identify a second set of symbols having a second number of symbols in second metadata of the configuration file for the decode phase, whereby each symbol in the second set of symbols is associated with the first token and/or the key or value of the KV cache previously stored in the associated memory circuitry.

By way of example, the compiler may verify that the second number of symbols is equal to the first number of symbols, and for each symbol in the second set of symbols, associate the symbol with a corresponding symbol in the first set of symbols.

If desired, compiler may raise an error in response to detecting that the second number of symbols is different than the first number of symbols or that one of the symbols in the second set of symbols fails to be associated with a corresponding symbol in the first set of symbols.

Illustratively, the compiler may verify that each symbol in the second set of symbols and the corresponding symbol in the first set of symbols is associated with a same location and a same layout in the memory circuitry.

If desired, the compiler may raise an error in response to detecting that one of the symbols in the second set of symbols fails to be associated with a same location and a same layout in the memory circuitry as the corresponding symbol in the first set of symbols.

In some implementations, when storing the data partitions according to a predetermined physical layout in the memory circuitry, the compiler can for each data partition of the data partitions, store elements of the data partition in a predetermined order in the memory circuitry.

In these implementations, when retrieving the data partitions according to the predetermined physical layout from the memory circuitry, the compiler can for each data partition of the data partitions, retrieve the elements of the data partition in the predetermined order from the memory circuitry.

### PARTICULAR IMPLEMENTATIONS

Described implementations of the subject matter can include one or more features, alone or in combination.

As an example, a data processing system comprises a first pool of reconfigurable processor circuitry; first memory circuitry, coupled to the first pool of reconfigurable processor circuitry; a second pool of reconfigurable processor circuitry that is different than the first pool of reconfigurable processor circuitry; second memory circuitry, that is different than the first memory circuitry and coupled to the second pool of reconfigurable processor circuitry; a direct memory access (DMA) transfer engine for transferring data from the first memory circuitry to the second memory circuitry over a network; one or more host processors coupled to a storage medium; and a compiler executable in any of the one or more host processors. The compiler configured to: generate a first configuration file for configuring the first pool of reconfigurable processor circuitry to implement a prefill phase of an LLM inference on the first pool of reconfigurable processor circuitry, comprising generating first instructions for: receiving a prompt, generating a token based on the prompt, partitioning the token into data partitions, and storing the data partitions according to a predetermined physical layout in the first memory circuitry, and generate a second configuration file for configuring the second pool of reconfigurable processor circuitry based on the first configuration file to implement a decode phase of the LLM inference on the second pool of reconfigurable processor circuitry, comprising generating second instructions for: retrieving the data partitions according to the predetermined physical layout from the second memory circuitry, forming the token from the data partitions, and generating an output based on the token.

The foregoing example and other described implementations can each, optionally, include one or more of the following features:
(2) the first and second pools of reconfigurable processor circuitry comprise arrays of coarse-grained reconfigurable (CGR) units.
(3) the DMA transfer engine is executable in any of the one or more host processors and configured to: retrieve the data partitions from the first memory circuitry; and send the data partitions through the network to the second memory circuitry.
(4) storing the data partitions according to a predetermined physical layout in the first memory circuitry further comprises: writing each data partition of the data partitions as a single block to the first memory circuitry.
(5) retrieving the data partitions according to the predetermined layout from the second memory circuitry further comprises: reading each data partition of the data partitions as a single block from the second memory circuitry.
(6) the compiler is further configured to receive partitioning instructions for partitioning the token into the data partitions, and wherein partitioning the token into data partitions further comprises: partitioning the token into the data partitions according to the partitioning instructions.
(7) retrieving the data partitions according to the predetermined physical layout from the second memory circuitry further comprises: identifying a first set of symbols having a first number of symbols with a first grouping of symbols in first metadata of the first configuration file, wherein each symbol in the first set of symbols is associated with a different data partition of the data partitions; and generating second metadata in the second configuration file including a second set of symbols having a second number of symbols, wherein each symbol in the second set of symbols is associated with another different data partition of the data partitions, and wherein the second number of symbols is equal to the first number of symbols.
(8) retrieving the data partitions according to the predetermined physical layout from the second memory circuitry further comprises: for each symbol in the second set of symbols, associating the symbol with a corresponding symbol in the first set of symbols such that the symbol in the second set of symbols is associated with a same data partition of the data partitions as the corresponding symbol in the first set of symbols.
(9) storing the data partitions according to a predetermined physical layout in the first memory circuitry further comprises: for each data partition of the data partitions, storing elements of the data partition in a predetermined order in the first memory circuitry.
(10) retrieving the data partitions according to the predetermined physical layout from the second memory circuitry further comprises: for each data partition of the data partitions, retrieving the elements of the data partition in the predetermined order from the second memory circuitry.

As another example, a method of operating a compiler in a data processing system, the data processing system comprising a first pool of reconfigurable processor circuitry, first memory circuitry, coupled to the first pool of reconfigurable processor circuitry, a second pool of reconfigurable processor circuitry that is different than the first pool of reconfigurable processor circuitry, second memory circuitry, that is different than the first memory circuitry and coupled to the second pool of reconfigurable processor circuitry, a direct memory access (DMA) transfer engine for transferring data from the first memory circuitry to the second memory circuitry over a network, and one or more processors coupled to a storage medium, wherein the compiler is executable in any of the one or more processors, comprises: generating a first configuration file for configuring the first pool of reconfigurable processor circuitry to implement a prefill phase of an LLM inference on the first pool of reconfigurable processor circuitry, comprising generating first instructions for: receiving a prompt, generating a token based on the prompt, partitioning the token into data partitions, and storing the data partitions according to a predetermined physical layout in the first memory circuitry, and generating a second configuration file for configuring the second pool of reconfigurable processor circuitry based on the first configuration file to implement a decode phase of the LLM inference on the second pool of reconfigurable processor circuitry, comprising generating second instructions for: retrieving the data partitions according to the predetermined physical layout from the second memory circuitry, forming the token from the data partitions, and generating an output based on the token.

The foregoing example and other described implementations can each, optionally, include one or more of the following features:
(1) storing the data partitions according to a predetermined physical layout in the first memory circuitry further comprises: writing each data partition of the data partitions as a single block to the first memory circuitry.
(2) retrieving the data partitions according to the predetermined layout from the second memory circuitry further comprises: reading each data partition of the data partitions as a single block from the second memory circuitry.
(3) retrieving the data partitions according to the predetermined physical layout from the second memory circuitry further comprises: identifying a first set of symbols having a first number of symbols with a first grouping of symbols in first metadata of the first configuration file, wherein each symbol in the first set of symbols is associated with a different data partition of the data partitions.
(4) retrieving the data partitions according to the predetermined physical layout from the second memory circuitry further comprises: generating second metadata in the second configuration file including a second set of symbols having a second number of symbols, wherein each symbol in the second set of symbols is associated with another different data partition of the data partitions, and wherein the second number of symbols is equal to the first number of symbols.
(5) retrieving the data partitions according to the predetermined physical layout from the second memory circuitry further comprises: for each symbol in the second set of symbols, associating the symbol with a corresponding symbol in the first set of symbols such that the symbol in the second set of symbols is associated with a same data partition of the data partitions as the corresponding symbol in the first set of symbols.
(6) storing the data partitions according to a predetermined physical layout in the first memory circuitry further comprises: for each data partition of the data partitions, storing elements of the data partition in a predetermined order in the first memory circuitry.
(7) retrieving the data partitions according to the predetermined physical layout from the second memory circuitry further comprises: for each data partition of the data partitions, retrieving the elements of the data partition in the predetermined order from the second memory circuitry.

As another example, a non-transitory computer-readable storage medium includes instructions that, when executed by a processing unit, cause the processing unit to operate a compiler in a data processing system, the data processing system comprising a first pool of reconfigurable processor circuitry, first memory circuitry, coupled to the first pool of reconfigurable processor circuitry, a second pool of reconfigurable processor circuitry that is different than the first pool of reconfigurable processor circuitry, second memory circuitry, that is different than the first memory circuitry and coupled to the second pool of reconfigurable processor circuitry, and a direct memory access (DMA) transfer engine for transferring data from the first memory circuitry to the second memory circuitry over a network, the instructions comprising: generating a first configuration file for configuring the first pool of reconfigurable processor circuitry to implement a prefill phase of an LLM inference on the first pool of reconfigurable processor circuitry, comprising generating first instructions for: receiving a prompt, generating a token based on the prompt, partitioning the token into data partitions, and storing the data partitions according to a predetermined physical layout in the first memory circuitry, and generating a second configuration file for configuring the second pool of reconfigurable processor circuitry based on the first configuration file to implement a decode phase of the LLM inference on the second pool of reconfigurable processor circuitry, comprising generating second instructions for: retrieving the data partitions according to the predetermined physical layout from the second memory circuitry, forming the token from the data partitions, and generating an output based on the token.

The foregoing example and other described implementations can each, optionally, include one or more of the following features:
(1) the instructions can further comprise: identifying a first set of symbols having a first number of symbols with a first grouping of symbols in first metadata of the first configuration file, wherein each symbol in the first set of symbols is associated with a different data partition of the data partitions; generating second metadata in the second configuration file including a second set of symbols having a second number of symbols, wherein each symbol in the second set of symbols is associated with another different data partition of the data partitions, and wherein the second number of symbols is equal to the first number of symbols; and for each symbol in the second set of symbols, associating the symbol with a corresponding symbol in the first set of symbols such that the symbol in the second set of symbols is associated with a same data partition of the data partitions as the corresponding symbol in the first set of symbols.

### CONSIDERATIONS

We describe various implementations of implementing memory sharing in a reconfigurable processor circuit.

The technology disclosed can be practiced as an apparatus, method, composition of matter, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections-these recitations are hereby incorporated forward by reference into each of the implementations described herein.

Although the description has been described with respect to specific implementations thereof, these specific implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to specific implementations thereof, these specific implementations are merely illustrative, and not restrictive. For instance, many of the operations can be implemented on a printed circuit board (PCB) using off-the-shelf devices, in a System-on-Chip (SoC), application-specific integrated circuit (ASIC), programmable processor, a coarse-grained reconfigurable architecture (CGRA), or in a programmable logic device such as a field-programmable gate array (FPGA), obviating the need for at least part of any dedicated hardware. Implementations may be as a single chip, or as a multi-chip module (MCM) packaging multiple semiconductor dies in a single package. All such variations and modifications are to be considered within the ambit of the disclosed technology the nature of which is to be determined from the foregoing description.

Any suitable technology for manufacturing electronic devices can be used to implement the circuits of specific implementations, including CMOS, FinFET, GAAFET, BiCMOS, bipolar, JFET, MOS, NMOS, PMOS, HBT, MESFET, etc. Different semiconductor materials can be employed, such as silicon, germanium, SiGe, GaAs, InP, GaN, SiC, graphene, etc. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different specific implementations. In some specific implementations, multiple elements, devices, or circuits shown as sequential in this specification can be operating in parallel.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

It will also be appreciated that one or more of the elements depicted in the drawings/figures can also be implemented in a more separated or integrated manner, or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

1. A data processing system, comprising:
a first pool of reconfigurable processor circuitry;
first memory circuitry, coupled to the first pool of reconfigurable processor circuitry;
a second pool of reconfigurable processor circuitry that is different than the first pool of reconfigurable processor circuitry;
second memory circuitry, that is different than the first memory circuitry and coupled to the second pool of reconfigurable processor circuitry;
a direct memory access (DMA) transfer engine for transferring data from the first memory circuitry to the second memory circuitry over a network;
one or more host processors coupled to a storage medium; and
a compiler executable in any of the one or more host processors, the compiler configured to:
generate a first configuration file for configuring the first pool of reconfigurable processor circuitry to implement a prefill phase of an LLM inference on the first pool of reconfigurable processor circuitry, comprising generating first instructions for: receiving a prompt, generating a token based on the prompt, partitioning the token into data partitions, and storing the data partitions according to a predetermined physical layout in the first memory circuitry, and
generate a second configuration file for configuring the second pool of reconfigurable processor circuitry based on the first configuration file to implement a decode phase of the LLM inference on the second pool of reconfigurable processor circuitry, comprising generating second instructions for: retrieving the data partitions according to the predetermined physical layout from the second memory circuitry, forming the token from the data partitions, and generating an output based on the token.

2. The data processing system of claim 1, wherein the first and second pools of reconfigurable processor circuitry comprise arrays of coarse-grained reconfigurable (CGR) units.

3. The data processing system of claim 1, wherein the DMA transfer engine is executable in any of the one or more host processors and configured to:
retrieve the data partitions from the first memory circuitry; and
send the data partitions through the network to the second memory circuitry.

4. The data processing system of claim 1, wherein storing the data partitions according to a predetermined physical layout in the first memory circuitry further comprises:
writing each data partition of the data partitions as a single block to the first memory circuitry.

5. The data processing system of claim 4, wherein retrieving the data partitions according to the predetermined layout from the second memory circuitry further comprises:
reading each data partition of the data partitions as a single block from the second memory circuitry.

6. The data processing system of claim 1, wherein the compiler is further configured to receive partitioning instructions for partitioning the token into the data partitions, and wherein partitioning the token into data partitions further comprises:
partitioning the token into the data partitions according to the partitioning instructions.

7. The data processing system of claim 1, wherein retrieving the data partitions according to the predetermined physical layout from the second memory circuitry further comprises:
identifying a first set of symbols having a first number of symbols with a first grouping of symbols in first metadata of the first configuration file, wherein each symbol in the first set of symbols is associated with a different data partition of the data partitions; and
generating second metadata in the second configuration file including a second set of symbols having a second number of symbols, wherein each symbol in the second set of symbols is associated with another different data partition of the data partitions, and wherein the second number of symbols is equal to the first number of symbols.

8. The data processing system of claim 7, wherein retrieving the data partitions according to the predetermined physical layout from the second memory circuitry further comprises:
for each symbol in the second set of symbols, associating the symbol with a corresponding symbol in the first set of symbols such that the symbol in the second set of symbols is associated with a same data partition of the data partitions as the corresponding symbol in the first set of symbols.

9. The data processing system of claim 1, wherein storing the data partitions according to a predetermined physical layout in the first memory circuitry further comprises:
for each data partition of the data partitions, storing elements of the data partition in a predetermined order in the first memory circuitry.

10. The data processing system of claim 9, wherein retrieving the data partitions according to the predetermined physical layout from the second memory circuitry further comprises:
for each data partition of the data partitions, retrieving the elements of the data partition in the predetermined order from the second memory circuitry.

11. A method of operating a compiler in a data processing system, the data processing system comprising a first pool of reconfigurable processor circuitry, first memory circuitry, coupled to the first pool of reconfigurable processor circuitry, a second pool of reconfigurable processor circuitry that is different than the first pool of reconfigurable processor circuitry, second memory circuitry, that is different than the first memory circuitry and coupled to the second pool of reconfigurable processor circuitry, a direct memory access (DMA) transfer engine for transferring data from the first memory circuitry to the second memory circuitry over a network, and one or more processors coupled to a storage medium, wherein the compiler is executable in any of the one or more processors, comprising:
generating a first configuration file for configuring the first pool of reconfigurable processor circuitry to implement a prefill phase of an LLM inference on the first pool of reconfigurable processor circuitry, comprising generating first instructions for: receiving a prompt, generating a token based on the prompt, partitioning the token into data partitions, and storing the data partitions according to a predetermined physical layout in the first memory circuitry, and
generating a second configuration file for configuring the second pool of reconfigurable processor circuitry based on the first configuration file to implement a decode phase of the LLM inference on the second pool of reconfigurable processor circuitry, comprising generating second instructions for: retrieving the data partitions according to the predetermined physical layout from the second memory circuitry, forming the token from the data partitions, and generating an output based on the token.

12. The method of claim 11, wherein storing the data partitions according to a predetermined physical layout in the first memory circuitry further comprises:
writing each data partition of the data partitions as a single block to the first memory circuitry.

13. The method of claim 12, wherein retrieving the data partitions according to the predetermined layout from the second memory circuitry further comprises:
reading each data partition of the data partitions as a single block from the second memory circuitry.

14. The method of claim 11, wherein retrieving the data partitions according to the predetermined physical layout from the second memory circuitry further comprises:
identifying a first set of symbols having a first number of symbols with a first grouping of symbols in first metadata of the first configuration file, wherein each symbol in the first set of symbols is associated with a different data partition of the data partitions.

15. The method of claim 14, wherein retrieving the data partitions according to the predetermined physical layout from the second memory circuitry further comprises:
generating second metadata in the second configuration file including a second set of symbols having a second number of symbols, wherein each symbol in the second set of symbols is associated with another different data partition of the data partitions, and wherein the second number of symbols is equal to the first number of symbols.

16. The method of claim 15, wherein retrieving the data partitions according to the predetermined physical layout from the second memory circuitry further comprises:
for each symbol in the second set of symbols, associating the symbol with a corresponding symbol in the first set of symbols such that the symbol in the second set of symbols is associated with a same data partition of the data partitions as the corresponding symbol in the first set of symbols.

17. The method of claim 11, wherein storing the data partitions according to a predetermined physical layout in the first memory circuitry further comprises:
for each data partition of the data partitions, storing elements of the data partition in a predetermined order in the first memory circuitry.

18. The method of claim 17, wherein retrieving the data partitions according to the predetermined physical layout from the second memory circuitry further comprises:
for each data partition of the data partitions, retrieving the elements of the data partition in the predetermined order from the second memory circuitry.

19. A non-transitory computer-readable storage medium including instructions that, when executed by a processing unit, cause the processing unit to operate a compiler in a data processing system, the data processing system comprising a first pool of reconfigurable processor circuitry, first memory circuitry, coupled to the first pool of reconfigurable processor circuitry, a second pool of reconfigurable processor circuitry that is different than the first pool of reconfigurable processor circuitry, second memory circuitry, that is different than the first memory circuitry and coupled to the second pool of reconfigurable processor circuitry, and a direct memory access (DMA) transfer engine for transferring data from the first memory circuitry to the second memory circuitry over a network, the instructions comprising:
generating a first configuration file for configuring the first pool of reconfigurable processor circuitry to implement a prefill phase of an LLM inference on the first pool of reconfigurable processor circuitry, comprising generating first instructions for: receiving a prompt, generating a token based on the prompt, partitioning the token into data partitions, and storing the data partitions according to a predetermined physical layout in the first memory circuitry, and
generating a second configuration file for configuring the second pool of reconfigurable processor circuitry based on the first configuration file to implement a decode phase of the LLM inference on the second pool of reconfigurable processor circuitry, comprising generating second instructions for: retrieving the data partitions according to the predetermined physical layout from the second memory circuitry, forming the token from the data partitions, and generating an output based on the token.

20. The non-transitory computer-readable storage medium of claim 19, wherein the instructions further comprise:
identifying a first set of symbols having a first number of symbols with a first grouping of symbols in first metadata of the first configuration file, wherein each symbol in the first set of symbols is associated with a different data partition of the data partitions;
generating second metadata in the second configuration file including a second set of symbols having a second number of symbols, wherein each symbol in the second set of symbols is associated with another different data partition of the data partitions, and wherein the second number of symbols is equal to the first number of symbols; and
for each symbol in the second set of symbols, associating the symbol with a corresponding symbol in the first set of symbols such that the symbol in the second set of symbols is associated with a same data partition of the data partitions as the corresponding symbol in the first set of symbols.
